(19) United States
(12) Patent Application Publication
(10) Pub. No.: US 2014/0039941 A1
(43) Pub. Date: Feb. 6, 2014

(54) Systems and Methods For An On-Line Sports Wagers Marketplace

(71) Applicants: Grant Alvernaz, Pleasant Hill, CA (US); Daniel Lee Alexander, Walnut Creek, CA (US)

(72) Inventors: Grant Alvernaz, Pleasant Hill, CA (US); Daniel Lee Alexander, Walnut Creek, CA (US)

(73) Assignee: Double-A Partners LLC

(21) Appl. No.: 13/562,610

(22) Filed: Jul. 31, 2012

(51) Int. Cl. G06Q 10/02

(52) U.S. Cl. 705/5

(57) ABSTRACT

Systems and methods provide an on-line sports wagers and intermediary marketplace for exchanging physical tickets related to future sporting events. Registration at a website and maintenance of user information allow the start of on-line transactions utilizing the system. A user interface for selecting and displaying a minimum price and a maximum price for a physical ticket and a communication network for communicating among user terminals, servers, data repositories, and other computers over the Internet control the on-line system to provide a proxy for escrow accounts used in funding the transactions after legitimacy of a ticket has been verified and to complete the on-line transactions when a successful purchase of the ticket has been communicated. In one aspect, a system can deposit a net value, if any, of a ticket to a proper escrow account after outcome of the future sporting event represented by the ticket has been determined.

### FIELD OF THE INVENTION

This invention relates generally to the systems and methods of an on-line sports wagers marketplace that can be used to exchange physical tickets representing wagers on future sporting events applying a provided database to safely match buyers and sellers.

### BACKGROUND

Fans of sporting events follow their favorite teams' performance and anticipate outcome of future sporting events. Excited football fans or baseball fans can engage in betting on anticipated outcomes of major sporting events such as the Super Bowl and the World Series by purchasing their wagers from a sports book. Under a typical situation, people who engage in betting on a future sporting event wait until the actual outcome has been determined from the future sporting event to exchange their purchased wagers for value only if they have selected a winning team. Unlike a commodity such as a stock in a nationally traded stock exchange market, valuable considerations paid in exchange to purchase a wager on a future sporting event normally do not have a nationally traded market to exchange the purchased wager for its intermediary value. An object of the current invention is to provide a safe intermediary marketplace over the Internet, where multiple people may participate at an on-line sports wagers marketplace using the systems and methods to buy and sell transferable physical tickets, including the tickets representing wagers on future sporting events.

For example, sporting fans may purchase wagers from a sports book in Las Vegas for their favorite football team to win the Super Bowl in next year based on the currently available statistics and news on their favorite football team. While the sporting fans wait for a year until the scheduled Super Bowl event in next year, the sporting fans may change their mind and decide that their favorite team would not win the next Super Bowl after more diligent review of the team players' skills. These sporting fans would want to sell their purchased wagers before the next Super Bowl event occurs. Since the scheduled Super Bowl event has not yet occurred, the purchased wagers may have intermediary values as long as the wagers are transferable and desired by other people who come to a different conclusion than these sporting fans.

Intermediary value of already purchased tickets representing wagers on future sporting events may be discounted and different from a similar ticket that can be purchased for the same future sporting event from a sports book at a particular time. Sellers of the purchased tickets may want to choose a considerably low price to sell their tickets before they entirely lose value of the tickets upon occurrence of the future sporting event. Buyers, who are looking for the purchased tickets, may be enticed to purchase the tickets due to the low price or because the tickets are no longer available from a sports book. Already purchased tickets such as the placed wagers on future sporting events can be exchanged at an on-line sports wagers marketplace where the security and process are controlled and maintained to avoid fraudulent attempts to sell void tickets or to prevent losing of valuable wagers without obtaining proceeds from their sales.

Use of escrow accounts at the on-line sports wagers marketplace can reduce fraudulent transactions by seizing the physical tickets and securing available funds necessary to cover the transactions. Communication among multiple computers and servers over the Internet enables buyers to participate in an exciting auction at the on-line sports wagers marketplace for bidding on a wager that has been already purchased from a sports book. Without depending on chances or luck, a buyer can purchase a physical ticket representing an already purchased wager for a future sporting event over the Internet by entering bids on the ticket based on the buyer's estimated intermediary value of the ticket. A seller of the ticket representing already purchased wager may be able to enjoy immediate distribution of an intermediary value of the ticket upon selling of the ticket at the on-line sports wagers marketplace instead of relying on a chance of the seller's ticket becoming a winning wager in future.

### SUMMARY OF THE INVENTION

This invention relates generally to the systems and methods of an on-line sports wagers marketplace that can be used to exchange physical tickets representing wagers on future sporting events applying a provided database to safely match buyers and sellers. An object of the current invention is to provide a safe intermediary marketplace over the Internet, where multiple people participate at an on-line sports wagers marketplace using the systems and methods to buy and sell transferable physical tickets, including the tickets representing wagers on future sporting events. The registration process and maintenance of user information offer people a safe market environment for having protected personal identifiers and storing preferred notification methods. A user interface of the system allows selecting of desired prices for selling and buying of the tickets at the on-line sports wagers marketplace. Sellers of the tickets deposit or transfer their tickets into their escrow accounts linked to the on-line sports wagers marketplace system. A proxy for escrow accounts allocates fund necessary to purchase tickets and can even deposit a successfully purchased ticket in an appropriate escrow account as authorized by registered users. Prior to completing any on-line transactions associated with a transferable physical ticket at the on-line sports wagers marketplace, the system is enabled to communicate with multiple user terminals, computers, servers, and data repositories over the Internet to compare entered prices and to verify legitimacy of the ticket information in order to avoid fraudulent transactions. Communication among multiple computers and servers over the Internet also allows buyers to participate in an exciting auction at the on-line sports wagers marketplace for bidding on a wager that has been already purchased from a sports book. For example, the communication network accesses purchase information associated with the ticket, which represents a wager on a future pro-foot ball sporting event, from a sports book to verify that the ticket is legitimate before the system transfers fund necessary to purchase the particular ticket from the buyer's escrow account to the seller's escrow account and notifies the buyer of the successful purchase of the ticket while withholding the particular ticket out of the seller's escrow account.

According to one embodiment, an on-line sports wagers marketplacesystem comprises a registration module to input user information in a database and to register with the on-line sports wagers marketplace system as a registered user; a user interface module having a template, a user input interface for the registered user to register with the on-line sports wagers marketplace system, and a proxy for escrow accounts on a website, wherein the website provides an intermediary marketplace for selling and buying transferable physical tickets related to future sporting events, and wherein the user input interface allowing to enter one or more inputs selected from a group consisting of protected login, numeric, alphanumeric, image, audio, video, hyperlink, and text entries, and wherein the proxy for escrow accounts allows to confirm, secure, and transfer available fund in said escrow accounts in conjunction with transactions involving selling and buying the transferable physical tickets; and a communication module for communicating with the user interface module and one or more items from a group consisting of a user terminal, the database, a data repository, an escrow account, a server, and an algorithm module, and wherein the algorithm module is capable of querying, evaluating, and displaying data such that the data are communicated using the communication module.

In certain aspects of the embodiment, the on-line sports wagers marketplace system may further comprise the registration module that includes a preferred notification contact means in the user information. In a particular aspect of the embodiment, the on-line sports wagers marketplace system includes, although not required, the registration module that further comprises of one or more preferred notification contact means from a group consisting of a mail, an expedited service mail, a certified mail, an insured mail, a telephone call, or an electronic transmission in the user information. In other aspects of the embodiment, the on-line sports wagers marketplace system may further include a feature within the user interface module which is adapted to further allow the registered user to designate the communication module and the algorithm module authorized to access the user information, the database, and the escrow accounts related to on-line sports wagers marketplace transactions by the registered user, wherein the communication module and the algorithm module are adapted to further allow verification of data, transfer of funds in the escrow accounts, and display a transaction status related to the on-line sports wagers marketplace transactions by the registered user. In another aspect of the embodiment, the on-line sports wagers marketplace system may include the template that further comprises of selection and displays of the transferable physical tickets, minimum prices chosen to sell the transferable physical tickets, maximum prices determined by the algorithm module to sell the transferable physical tickets, and buyers determined by the algorithm module to successfully purchase the transferable physical tickets. In yet another aspect of the embodiment, the on-line sports wagers marketplace system may be further adopted as an on-line auction marketplace system that further provides auctioning of said transferable physical tickets.

According to another embodiment, a method for providing an on-line sports wagers marketplace system comprises following steps: registering in a database and maintaining user information in the database; providing a user interface module having a template, a user interface for a registered user, and a proxy for escrow accounts on a website such that the website provides an intermediary marketplace for selling and buying Future Tickets wherein the Future Tickets are transferable physical tickets representing wagers on future sporting events; listing each of the Future Tickets with purchase information by a registered user who is a seller using the user interface module on the website; selecting a Bottom Price by the seller to sell each of the Future Tickets on the website wherein the Bottom Price is a minimum price chosen to sell at least one of the Future Tickets; providing a means, which may be a step of enabling an communication module and an algorithm module to access and cause although not required, for the database to retrieve a market price of a wager for the future sporting event from at least another data repository to calculate a Donkey Discount wherein the Donkey Discount is at least 96% of the market price and a maximum price determined to sell at least one of the Future Tickets; verifying legitimacy of each of the Future Tickets by securing the Future Tickets from sellers and confirming the purchase information in the database against the data repository; displaying each of the Future Tickets with the Bottom Price and the Donkey Discount on the website; selecting the Donkey Discount to purchase each of the Future Tickets by a plurality of the registered user who is a buyer on the website; providing a means for determining the buyer for each of the Future Tickets by retrieving and evaluating a plurality of the Donkey Discount; notifying selling of each of the Future Tickets to the seller and the buyer after confirming available fund equal to payment amount for each of the Future Tickets in the escrow account designated to the buyer; and distributing of each of the Future Tickets to the buyer and the available fund equal to payment amount for each of the Future Tickets to the seller.

According to another embodiment, a method for providing an on-line auction marketplace system comprises following steps: registering in a database and maintaining user information in the database; providing a user interface module having a template, a user interface for a registered user, and a proxy for escrow accounts on a website such that the website provides an intermediary marketplace for selling and buying Future Tickets wherein the Future Tickets are transferable physical tickets representing wagers on future sporting events; listing each of the Future Tickets with purchase information by a registered user who is a seller using the user interface module on the website; selecting a Bottom Price by the seller to sell each of the Future Tickets on the website wherein the Bottom Price is a minimum price chosen to sell at least one of the Future Tickets; providing a means, which may be a step of enabling an communication module and an algorithm module to access and cause although not required, for the database to retrieve a market price of a wager for the future sporting event from at least another data repository to calculate a Donkey Discount wherein the Donkey Discount is at least 96% of the market price and a maximum price determined to sell at least one of the Future Tickets; verifying legitimacy of each of the Future Tickets by securing the Future Tickets from sellers and confirming the purchase information in the database against the data repository; displaying each of the Future Tickets with the Bottom Price and the Donkey Discount on the website; entering a bid price in an auction to purchase each of the Future Tickets by a plurality of the registered user who is a buyer on the website; providing a means for determining an auction winner for each of the Future Tickets by retrieving and evaluating a plurality of the bid price; notifying selling of each of the Future Tickets to the seller and the auction winner after confirming available fund equal to payment amount for each of the Future Tickets in the escrow account designated to the auction winner; and distributing of each of the Future Tickets to the auction winner and the available fund equal to payment amount for each of the Future Tickets to the seller.

In various aspects of the embodiments, an ordinary skilled person in this field of art should understand that first embodiment of the embodiments is the method for providing an on-line sports wagers marketplace system that includes selecting the Donkey Discount to purchase each of the Future Tickets by multiple registered users as described above. It shall be further understood by the ordinary skilled person in this field of art that second embodiment of the embodiments is the other method for providing an on-line auction marketplace system which includes entering the bid price in the auction to purchase each of the Future Tickets by multiple registered users at the website as described above. In certain aspects of the embodiments, the method from either first or second embodiment of the embodiments may further include providing a means for the database to retrieve a market price of a wager for the future sporting event from the data repository wherein the data repository is a sports book. Yet, in certain aspects of the embodiments, the method from either first or second embodiment of the embodiments may further comprise distributing of each of the Future Tickets to the auction winner by providing a means to hold each of the Future Tickets until a winning wager is determined for the future sporting event and to distribute a net value represented by the winning wager minus amount owed from transactions of exchanging each of the Future Tickets into the escrow account. In another aspect of the embodiments, the method from either first or second embodiment of the embodiments may further comprise auctioning for a predetermined period defined as from time each of the Future Tickets is displayed on the website for a purpose of the auctioning until a winner of the auctioning is notified, wherein the predetermined period is between 24 hours and 48 hours or until an entered price matches the Donkey Discount of each of the Future Tickets. In yet another aspect of the embodiments, the method from either first or second embodiment of the embodiments may further include registering in the database and maintaining the user information in the database wherein the database is a cloud application over Internet.

According to another embodiment, a method for providing an on-line sports wagers marketplace system comprising the following steps: registering and maintaining user information wherein the user information includes a protected personal identifier and a third party entity chosen to sponsor on-line transactions; providing a user interface module having a user interface for a registered user and a proxy for escrow accounts on a website such that the website provides an intermediary marketplace for selling and buying transferable physical tickets related to future sporting events; editing using the user interface module to list the transferable physical tickets with minimum prices for selling the transferable physical tickets and maximum prices for buying the transferable physical tickets; verifying legitimacy of the transferable physical tickets by retrieving market prices and purchase information associated with the transferable physical tickets from at least another data repository and securing the transferable physical tickets; starting the on-line transactions for entering prices on the website to sell and buy the transferable physical tickets with the minimum prices and the maximum prices; and completing the on-line transactions for selling and buying of the transferable physical tickets on the website, wherein before the completion of the on-line transactions confirming available fund in the escrow accounts to pay for the transferable physical tickets, having evaluated a plurality of the prices entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions.

In various aspects of the embodiment, the method may further include registering and maintaining the user information which includes a preferred notification contact means. In certain aspects of the embodiment, the method further comprises registering and maintaining the user information that includes the preferred notification contact means wherein the preferred notification contact means is a mail, an expedited service mail, a certified mail, an insured mail, a telephone call, or an electronic transmission. In other aspects of the embodiment, the method may further include providing a means to enable the user interface module retrieving a plurality of data repository and servers. In certain aspects of the embodiment, the method may further comprise of providing the user interface module wherein the user interface module includes a template to list the transferable physical tickets, the minimum prices, and the maximum prices. In another aspect of the embodiment, the method may further comprise a step of auctioning for a predetermined period defined as from time at least one of the transferable physical tickets are displayed on the website for a purpose of the auctioning until a winner of the auctioning for at least one of the transferable physical tickets is notified, wherein the predetermined period is between 24 hours and 48 hours or until each of the prices matches each of the maximum prices, and wherein the on-line sports wagers marketplace is an on-line auction marketplace. In yet another aspect of the embodiment, the method may further include editing using the user interface module to list the transferable physical tickets with the minimum prices for selling the transferable physical tickets and the maximum prices for buying the transferable physical tickets, and wherein the transferable physical tickets are Future Tickets representing wagers on future sporting events, and wherein the minimum prices are Bottom Prices selected by the sellers to sell the Future Tickets, and wherein the maximum prices are Donkey Discounts and at least 96% of the market prices. In a different aspect of the embodiment, the method is further adapted for distributing of the Future Tickets to winners of the on-line auction marketplace by providing a means to hold the Future Tickets until winning wagers are determined for the future sporting events and to distribute net values represented by the winning wagers minus amount owed from transactions of exchanging the Future Tickets into the escrow accounts. In another different aspect of the embodiment, the method further includes verifying legitimacy of the transferable physical tickets wherein the registered users who enlist the transferable physical tickets in the on-line transactions by delivering the transferable physical tickets to a repository address provided on the website. In yet another aspect of the embodiment, the method may further comprise registering in the database and maintaining the user information in the database wherein the database is a cloud application over Internet.

In another embodiment, a method of providing on-line sports wagers marketplace system having a registration module to input user information in a database and registers with the system as a registered user, a user interface module having a template, a user input interface for the registered user, and a proxy for escrow accounts on a website, and a communication module for communicating with the user interface module and one or more items from a group consisting of a user terminal, the database, a data repository, an escrow account, a server, and an algorithm module wherein the algorithm module is capable of querying, evaluating, and displaying data such that the data are communicated using the communication module comprising the following steps: registering and maintaining user information wherein the user information includes a protected personal identifier and a third party entity chosen to sponsor on-line transactions; providing a user interface module having a user interface for a registered user and a proxy for escrow accounts on a website such that the website provides an intermediary marketplace for selling and buying transferable physical tickets related to future sporting events; editing using the user interface module to list the transferable physical tickets with minimum prices for selling the transferable physical tickets and maximum prices for buying the transferable physical tickets; verifying legitimacy of the transferable physical tickets by retrieving market prices and purchase information associated with the transferable physical tickets from at least another data repository and securing the transferable physical tickets; starting the on-line transactions for entering prices on the website to sell and buy the transferable physical tickets with the minimum prices and the maximum prices; and

completing the on-line transactions for selling and buying of the transferable physical tickets on the website, wherein before the completion of the on-line transactions confirming available fund in the escrow accounts to pay for the transferable physical tickets, having evaluated a plurality of the prices entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions.

In various aspects of the embodiment, the step of registering and maintaining the user information may further include, although not required, a preferred notification contact means. In certain aspects of the embodiment, the preferred notification contact means wherein the preferred notification contact means is a mail, an expedited service mail, a certified mail, an insured mail, a telephone call, or an electronic transmission. In other aspects of the embodiment, the method may further comprise a step of providing a means to enable the user interface module retrieving a plurality of data repository and servers. In another aspect of the embodiment, the user interface module may further include a template to list the transferable physical tickets, the minimum prices, and the maximum prices. In yet another aspect of the embodiment, the method further comprises of a step of auctioning for a predetermined period defined as from time at least one of the transferable physical tickets are displayed on the website for a purpose of the auctioning until a winner of the auctioning for at least one of the transferable physical tickets is notified, wherein the predetermined period is between 24 hours and 48 hours or until each of the prices matches each of the maximum prices, and wherein the on-line sports wagers marketplace is an on-line auction marketplace. In a different aspect of the embodiment, the method may further include a step of editing using the user interface module to list the transferable physical tickets with the minimum prices for selling the transferable physical tickets and the maximum prices for buying the transferable physical tickets, wherein the transferable physical tickets are Future Tickets representing wagers on future sporting events, and wherein the minimum prices are Bottom Prices selected by the sellers to sell the Future Tickets, and wherein the maximum prices are Donkey Discounts and at least 96% of the market prices. In certain aspects of the embodiment, the method may further comprise distributing of the Future Tickets to winners of the on-line auction marketplace by providing a means to hold the Future Tickets until winning wagers are determined for the future sporting events and to distribute net values represented by the winning wagers minus amount owed from transactions of exchanging the Future Tickets into the escrow accounts. In another aspect of the embodiment, the method may be further adapted for verifying legitimacy of the transferable physical tickets wherein the registered users who enlist the transferable physical tickets in the on-line transactions by delivering the transferable physical tickets to a repository address provided on the website. In yet another aspect of the embodiment, the method may further include registering in the database and maintaining the user information in the database wherein the database is a cloud application over Internet.

According to another embodiment, a computer implemented method that includes at least one non-transitory computer-usable readable storage medium having at least one non-transitory computer-readable program code embodied therein for causing a computer system to perform a method of providing an on-line sports wagers marketplace system as following: registering and maintaining user information wherein the user information includes a protected personal identifier and a third party entity chosen to sponsor on-line transactions; providing a user interface module having a user interface for a registered user and a proxy for escrow accounts on a website such that the website provides an intermediary marketplace for selling and buying transferable physical tickets related to future sporting events; editing using the user interface module to list the transferable physical tickets with minimum prices for selling the transferable physical tickets and maximum prices for buying the transferable physical tickets; verifying legitimacy of the transferable physical tickets by retrieving market prices and purchase information associated with the transferable physical tickets from at least another data repository and securing the transferable physical tickets; starting the on-line transactions for entering prices on the website to sell and buy the transferable physical tickets with the minimum prices and the maximum prices; and completing the on-line transactions for selling and buying of the transferable physical tickets on the website, wherein before the completion of the on-line transactions confirming available fund in the escrow accounts to pay for the transferable physical tickets, having evaluated a plurality of the prices entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions.

In various aspects of the embodiment, the computer implemented method may further comprise of registering and maintaining the user information wherein the user information includes a preferred notification contact means. In certain aspects of the embodiment, the computer implemented method further includes registering and maintaining the user information includes the preferred notification contact means wherein the preferred notification contact means is a mail, an expedited service mail, a certified mail, an insured mail, a telephone call, or an electronic transmission. In other aspects of the embodiment, the computer implemented method may further comprise a step of providing a means to enable the user interface module adapted for retrieving a plurality of data repository and servers. In another aspect of the embodiment, the computer implemented method may further include a template to list the transferable physical tickets, the minimum prices, and the maximum prices. In a particular aspect of the embodiment, the method further includes a step for auctioning for a predetermined period defined as from time at least one of the transferable physical tickets are displayed on the website for a purpose of the auctioning until a winner of the auctioning for at least one of the transferable physical tickets is notified, wherein the predetermined period is between 24 hours and 48 hours or until each of the prices matches each of the maximum prices, and wherein the on-line sports wagers marketplace is an on-line auction marketplace. In yet another aspect of the embodiment, the computer implemented method may further comprise editing using the user interface module to list the transferable physical tickets with the minimum prices for selling the transferable physical tickets and the maximum prices for buying the transferable physical tickets, wherein the transferable physical tickets are Future Tickets representing wagers on future sporting events, and wherein the minimum prices are Bottom Prices selected by the sellers to sell the Future Tickets, and wherein the maximum prices are Donkey Discounts and at least 96% of the market prices. In certain aspects of the embodiment, the computer implemented method further comprises distributing of the Future Tickets to winners of the on-line auction marketplace by providing a means to hold the Future Tickets until winning wagers are determined for the future sporting events and to distribute net values represented by the winning wagers minus amount owed from transactions of exchanging the Future Tickets into the escrow accounts. In a different aspect of the embodiment, the computer implemented method further includes verifying legitimacy of the transferable physical tickets wherein the registered users who enlist the transferable physical tickets in the on-line transactions by delivering the transferable physical tickets to a repository address provided on the website. In yet another aspect of the embodiment, the computer implemented method may further comprise registering in the database and maintaining the user information in the database wherein the database is a cloud application over Internet.

According to another embodiment, a computer-implemented platform including a non-transitory computer-usable readable storage medium having non-transitory computer-readable program codes embodied therein for causing an on-line sports wagers marketplace system computer system to perform steps in exchanging transferable physical tickets related to future sporting events comprises a custom computer platform; a registration module to input user information, wherein the user information includes a preferred notification contact means, and to register with the on-line sports wagers marketplace system as a registered user; a user interface module having a template and a user input interface for the registered user to register with the on-line sports wagers marketplace system, and a proxy for escrow accounts on a website, and wherein the website provides an intermediary marketplace for selling and buying transferable physical tickets related to future sporting events, and wherein the user input interface allowing to enter one or more inputs selected from a group consisting of protected login, numeric, alphanumeric, image, audio, video, hyperlink, and text entries, and wherein the proxy for escrow accounts allows to confirm, secure, and transfer available fund in the escrow accounts in conjunction with transactions involving selling and buying the transferable physical tickets; a database for storing the user information for the registered user, wherein the user information is identified to the registered user and enabled for querying, evaluating, and displaying; and a communication module for communicating with the user interface module and one or more items from a group consisting of a user terminal, the database, a data repository, an escrow account, a server, and an algorithm module, wherein the algorithm module is capable of querying, evaluating, and displaying data such that the data are communicated using the communication module.

In various aspects of the embodiment, the computer-implemented platform may include the registration module that further comprises of one or more preferred notification contact means from a group consisting of a mail, an expedited service mail, a certified mail, an insured mail, a telephone call, or an electronic transmission in the user information. In other aspects of the embodiment, the computer-implemented platform may further include a feature within the user interface module that is adapted to further allow the registered user to designate the communication module and the algorithm module authorized to access the user information, the database, and the escrow accounts related to on-line sports wagers marketplace transactions by the registered user, wherein the communication module and the algorithm module are adapted to further allow verification of data, transfer of funds in the escrow accounts, and display a transaction status related to the on-line sports wagers marketplace transactions by the registered user. In a particular aspect of the embodiment, the computer-implemented platform may further comprise, although not required, the template having selection and displays of the transferable physical tickets, minimum prices chosen to sell the transferable physical tickets, maximum prices determined by the algorithm module to sell the transferable physical tickets, and buyers determined by the algorithm module to successfully purchase the transferable physical tickets. In yet another particular aspect of the embodiment, the computer-implemented platform may be further enabled to cause the on-line sports wagers marketplace system to be an on-line auction marketplace system that further provides auctioning of said transferable physical tickets.

According to another embodiment, one or more processor readable storage devices, which include processor readable codes embodied on at least one processor readable storage device, and at least one processor readable storage device adopted by the processor readable codes to perform a method of providing an on-line sports wagers marketplace system comprising steps of registering and maintaining user information wherein the user information includes a protected personal identifier and a third party entity chosen to sponsor on-line transactions; providing a user interface module having a user interface for a registered user and a proxy for escrow accounts on a website such that the website provides an intermediary marketplace for selling and buying transferable physical tickets related to future sporting events; editing using the user interface module to list the transferable physical tickets with minimum prices for selling the transferable physical tickets and maximum prices for buying the transferable physical tickets; verifying legitimacy of the transferable physical tickets by retrieving market prices and purchase information associated with the transferable physical tickets from at least another data repository and securing the transferable physical tickets; starting the on-line transactions for entering prices on the website to sell and buy the transferable physical tickets with the minimum prices and the maximum prices; and

completing the on-line transactions for selling and buying of the transferable physical tickets on the website, wherein before the completion of the on-line transactions confirming available fund in the escrow accounts to pay for the transferable physical tickets, having evaluated a plurality of the prices entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions.

In various aspects of the embodiment, the one or more processor readable storage devices and at least one processor readable storage device adopted by the processor readable codes are further adapted to perform the method that may further comprise registering and maintaining the user information wherein the user information includes a preferred notification contact means. In other aspects of the embodiment, another further adaption enables performing the method which may include registering and maintaining the user information includes the preferred notification contact means wherein the preferred notification contact means is a mail, an expedited service mail, a certified mail, an insured mail, a telephone call, or an electronic transmission. In certain aspects of the embodiment, the method may further comprise providing a means to enable the user interface module that is capable of retrieving multiple data repository and servers. In a particular aspect of the embodiment, the method further includes providing the user interface module wherein the user interface module having a template to list the transferable physical tickets, the minimum prices, and the maximum prices. In a different aspect of the embodiment, the method may further comprise a step of auctioning for a predetermined period defined as from time at least one of the transferable physical tickets are displayed on the website for a purpose of the auctioning until a winner of the auctioning for at least one of the transferable physical tickets is notified, wherein the predetermined period is between 24 hours and 48 hours or until each of the prices matches each of the maximum prices, and wherein the on-line sports wagers marketplace is an on-line auction marketplace. In another aspect of the embodiment, the one or more processor readable storage devices and at least one processor readable storage device programmed by the processor readable codes further include a feature to perform the method that may further comprise editing using the user interface module to list the transferable physical tickets with the minimum prices for selling the transferable physical tickets and the maximum prices for buying the transferable physical tickets, wherein the transferable physical tickets are Future Tickets representing wagers on future sporting events, and wherein the minimum prices are Bottom Prices selected by the sellers to sell the Future Tickets, and wherein the maximum prices are Donkey Discounts and at least 96% of the market prices. In yet another aspect of the embodiment, the method may further comprise distributing of the Future Tickets to winners of the on-line auction marketplace by providing a means to hold the Future Tickets until winning wagers are determined for the future sporting events and to distribute net values represented by the winning wagers minus amount owed from transactions of exchanging the Future Tickets into the escrow accounts. In certain aspects of the embodiment, the method further comprises of verifying legitimacy of the transferable physical tickets wherein the registered users who enlist the transferable physical tickets in the on-line transactions by delivering the transferable physical tickets to a repository address provided on the website. In yet another aspect of the embodiment, the method is further allowed for registering in the database and maintaining the user information in the database wherein the database is a cloud application over Internet.

In another embodiment of this invention, a non-transitory computer-usable readable storage medium for an on-line sports wagers marketplace structure comprises (a) program code for registering and maintaining user information wherein the user information includes a protected personal identifier and a third party entity chosen to sponsor on-line auctions; (b) program code for providing a user interface module having a user interface for a registered user and a proxy for escrow accounts on a website such that the website provides an intermediary marketplace for selling and buying transferable physical tickets related to future sporting events; (c) program code for editing using the user interface module to list the transferable physical tickets with minimum prices for selling the transferable physical tickets and maximum prices for buying the transferable physical tickets; (d) program code for verifying legitimacy of the transferable physical tickets by retrieving market prices and purchase information associated with the transferable physical tickets from at least another data repository and securing the transferable physical tickets; (e) program code for starting said on-line transactions for entering prices on the website to sell and buy the transferable physical tickets with the minimum prices and the maximum prices; and (f) program code for completing the on-line transactions for selling and buying of the transferable physical tickets on the website, wherein before the completion of the on-line transactions confirming available fund in the escrow accounts to pay for the transferable physical tickets, having evaluated a plurality of the prices entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions.

According to another embodiment, at least one or more processor readable storage devices, which have processor readable codes embodied, are caused by the process readable codes to perform a method of providing an on-line sports wagers marketplace system for selling and buying Future Tickets comprising steps for having said on-line sports wagers marketplace system further adopted to provide an on-line auction marketplace system; registering in a database and maintaining user information in the database; providing a user interface module having a template, a user interface for a registered user, and a proxy for escrow accounts on a website such that the website provides an intermediary marketplace for selling and buying Future Tickets wherein the Future Tickets are transferable physical tickets representing wagers on future sporting events; listing each of the Future Tickets with purchase information by a registered user who is a seller using the user interface module on the website; selecting a Bottom Price by the seller to sell each of the Future Tickets on the website wherein the Bottom Price is a minimum price chosen to sell at least one of the Future Tickets; providing a means for the database to retrieve a market price of a wager for the future sporting event from at least another data repository to calculate a Donkey Discount wherein the Donkey Discount is at least 96% of the market price and a maximum price determined to sell at least one of the Future Tickets; verifying legitimacy of the Future Tickets by securing the Future Tickets from the sellers and confirming the purchase information in the database against the data repository; displaying each of the Future Tickets with the Bottom Price and the Donkey Discount on the website; entering a bid price in an auction to purchase each of the Future Tickets by a plurality of the registered user who is a buyer on the website; providing a means for determining an auction winner for each of the Future Tickets by retrieving and evaluating a plurality of the bid price; notifying selling of each of the Future Tickets to the seller and the auction winner after confirming available fund equal to payment amount for each of the Future Tickets in the escrow account designated to the auction winner; and distributing of each of the Future Tickets to the auction winner and the available fund equal to payment amount for each of the Future Tickets to the seller.

In various aspects of the embodiment, at least one or more of the processor readable storage devices are further adapted for performing the method that may further include providing a means for the database to retrieve a market price of a wager for the future sporting event from the data repository wherein the data repository is a sports book. In other aspects of the embodiment, the method may further include distributing of each of the Future Tickets to the auction winner by providing a means to hold each of the Future Tickets until a winning wager is determined for the future sporting event and to distribute a net value represented by the winning wager minus amount owed from transactions of exchanging each of the Future Tickets into the escrow account. In a particular aspect of the embodiment, the method may further comprise running the auction for a predetermined period defined as from time each of the Future Tickets is displayed on the website for a purpose of the auction until the auction winner is notified, wherein the predetermined period is between 24 hours and 48 hours or until the bid price matches the Donkey Discount of each of the Future Tickets. In yet another aspect of the embodiment, the method may further include registering in the database and maintaining the user information in the database wherein the database is a cloud application over Internet.

In another embodiment, a non-transitory computer-usable readable storage medium for an on-line sports wagers marketplace structure for selling and buying Future Tickets includes (a) program code for having the on-line sports wagers marketplace system further adopted to provide an on-line auction marketplace system; (b) program code for registering in a database and maintaining user information in the database; (c) program code for providing a user interface module having a template, a user interface for a registered user, and a proxy for escrow accounts on a website such that the website provides an intermediary marketplace for selling and buying Future Tickets wherein the Future Tickets are transferable physical tickets representing wagers on future sporting events; (d) program code for listing each of the Future Tickets with purchase information by a registered user who is a seller using the user interface module on the website; (e) program code for selecting a Bottom Price by the seller to sell each of the Future Tickets on the website wherein the Bottom Price is a minimum price chosen to sell at least one of the Future Tickets; (f) program code for providing a means for the database to retrieve a market price of a wager for the future sporting event from at least another data repository to calculate a Donkey Discount wherein the Donkey Discount is at least 96% of the market price and a maximum price determined to sell at least one of the Future Tickets; (g) program code for verifying legitimacy of the Future Tickets by securing the Future Tickets from the sellers and confirming the purchase information in the database against the data repository; (h) program code for displaying each of the Future Tickets with the Bottom Price and the Donkey Discount on the website; (i) program code for entering a bid price in an auction to purchase each of the Future Tickets by a plurality of the registered user who is a buyer on the website; (j) program code for providing a means for determining an auction winner for each of the Future Tickets by retrieving and evaluating a plurality of the bid price; (k) program code for notifying selling each of the Future Tickets to the seller and the auction winner after confirming available fund equal to payment amount for each of the Future Tickets in the escrow account designated to the auction winner; and (l) program code for distributing each of the Future Tickets to the auction winner and the available fund equal to payment amount for each of the Future Tickets to the seller.

### BRIEF DESCRIPTION OF THE DRAWINGS

FIG. 1 is a functional block diagram of an on-line sports wagers marketplace system.

FIG. 2 is a flow chart for a method for providing an on-line sports wagers marketplace system using Future Tickets, Bottom Prices, and Donkey Discounts.

FIG. 3 is a flow chart for a method for providing an on-line auction marketplace system using Future Tickets, Bottom Prices, and Donkey Discounts.

FIG. 4 is a flow chart for a method for providing an on-line sports wagers marketplace system.

FIG. 5 is a flow chart for a method for providing an on-line sports wagers marketplace system having a registration module, a user interface module, and a communication module.

FIG. 6 is a flow chart for a computer implemented method including at least one non-transitory computer-usable readable storage medium having at least one non-transitory computer-readable program code therein for causing a computer system to perform a method of providing an on-line sports wagers marketplace system.

FIG. 7 is a functional block diagram of a computer-implemented platform comprising a non-transitory computer-usable readable medium having non-transitory computer-readable program codes embodied therein for an on-line sports wagers marketplace computer system.

FIG. 8 is a flow chart for at least one processor readable storage device adopted by processor readable codes to perform a method of providing an on-line sports wagers marketplace system.

FIG. 9 is a functional block diagram of a non-transitory computer-usable readable storage medium for an on-line sports wagers marketplace structure.

FIG. 10 is a flow chart for at least one processor readable storage device adopted by processor readable codes to perform a method of providing an on-line sports wagers marketplace system for selling and buying Future Tickets.

FIG. 11 is a functional block diagram of a non-transitory computer-usable readable storage medium for an on-line sports wagers marketplace structure for selling and buying Future Tickets.

FIG. 12 is a block diagram illustrating components of an exemplary operating environment.

FIG. 13 is a functional block diagram of an exemplary computer system.

### DETAILED DESCRIPTION OF EXAMPLE EMBODIMENTS OF THE INVENTION

This invention relates generally to the systems and methods of an on-line sports wagers marketplace that can be used to exchange physical tickets representing wagers on future sporting events applying a provided database to safely match buyers and sellers. An object of the current invention is to provide a safe intermediary marketplace over the Internet, where multiple people may participate at an on-line sports marketplace using the systems and methods to buy and sell transferable physical tickets, including the tickets representing wagers on future sporting events. The registration process and maintenance of user information offer people a safe market environment for having protected personal identifiers and storing preferred notification methods. A user interface of the system allows selecting of desired prices for selling and buying of the tickets at the on-line sports wagers marketplace. Sellers of the tickets deposit or transfer their tickets into their escrow accounts linked to the on-line sports wagers marketplace system. A proxy for escrow accounts allocates fund necessary to purchase tickets and can even deposit a successfully purchased ticket in an appropriate escrow account as authorized by registered users. Prior to completing on-line transactions associated with a transferable physical ticket at the on-line sports wagers marketplace, the system is enabled to communicate with multiple user terminals, computers, servers, and data repositories over the Internet to compare entered prices and to verify legitimacy of the ticket information in order to avoid fraudulent transactions. Communication among multiple computers and servers over the Internet also allows buyers to participate in an exciting auction at the on-line sports wagers marketplace for bidding on a wager that has been already purchased from a sports book. For example, the communication network accesses purchase information associated with the ticket, which represents a wager on a future pro-foot ball sporting event, from a sports book to verify that the ticket is legitimate before the system transfers fund necessary to purchase the particular ticket from the buyer's escrow account to the seller's escrow account and notifies the buyer of the successful purchase of the ticket while withholding the particular ticket out of the seller's escrow account.

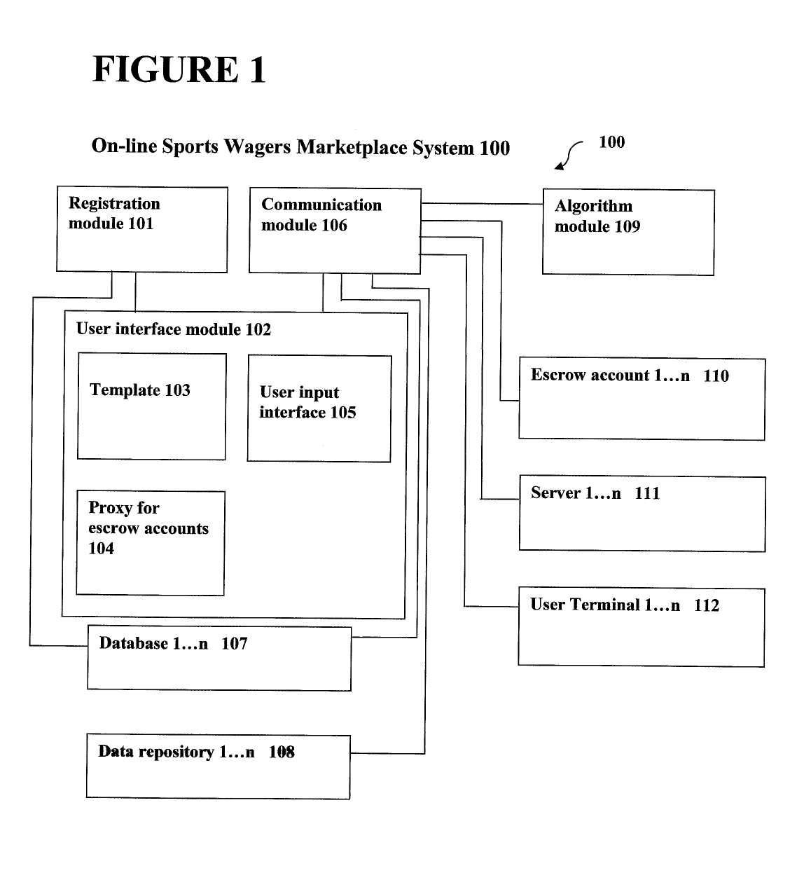

With reference to the drawings and particularly FIG. 1, an on-line sports wagers marketplace system 100 comprises a registration module 101 to input user information in a database 107 and to register with the on-line sports wagers marketplace system as a registered user; a user interface module 102 having a template 103 and a user input interface 105 for the registered user to register with the on-line sports wagers marketplace system, and a proxy for escrow accounts 104 on a website, wherein the website provides an intermediary marketplace for selling and buying transferable physical tickets related to future sporting events, and wherein the user input interface allowing to enter one or more inputs selected from a group consisting of protected login, numeric, alphanumeric, image, audio, video, hyperlink, and text entries, and wherein the proxy for escrow accounts 110 allows to confirm, secure, and transfer available fund in the escrow accounts in conjunction with transactions involving selling and buying the transferable physical tickets; and a communication module 106 for communicating with the user interface module and one or more items from a group consisting of a user terminal 112, the database, a data repository 108, an escrow account 110, a server 111, and an algorithm module 109, and wherein the algorithm module is capable of querying, evaluating, and displaying data such that the data are communicated using the communication module.

In certain aspects of the embodiment, the on-line sports wagers marketplace system may further comprise the registration module that further include a preferred notification contact means in the user information. In a particular aspect of the embodiment, the on-line sports wagers marketplace system includes, although not required, the registration module that further comprises of one or more preferred notification contact means from a group consisting of a mail, an expedited service mail, a certified mail, an insured mail, a telephone call, or an electronic transmission in the user information. In other aspects of the embodiment, the on-line sports wagers marketplace system may further include a feature within the user interface module which is adapted to further allow the registered user to designate the communication module and the algorithm module authorized to access the user information, the database, and the escrow accounts related to on-line sports wagers marketplace transactions by the registered user, wherein the communication module and the algorithm module are adapted to further allow verification of data, transfer of funds in the escrow accounts, and display a transaction status related to the on-line sports wagers marketplace transactions by the registered user. In yet another aspect of the embodiment, the on-line sports wagers marketplace system may include the template that further comprises of selection and displays of the transferable physical tickets, minimum prices chosen to sell the transferable physical tickets, maximum prices determined by the algorithm module to sell the transferable physical tickets, and buyers determined by the algorithm module to successfully purchase the transferable physical tickets. In yet another aspect of the embodiment, the on-line sports wagers marketplace system may be further adopted as an on-line auction marketplace system that further provides auctioning of said transferable physical tickets.

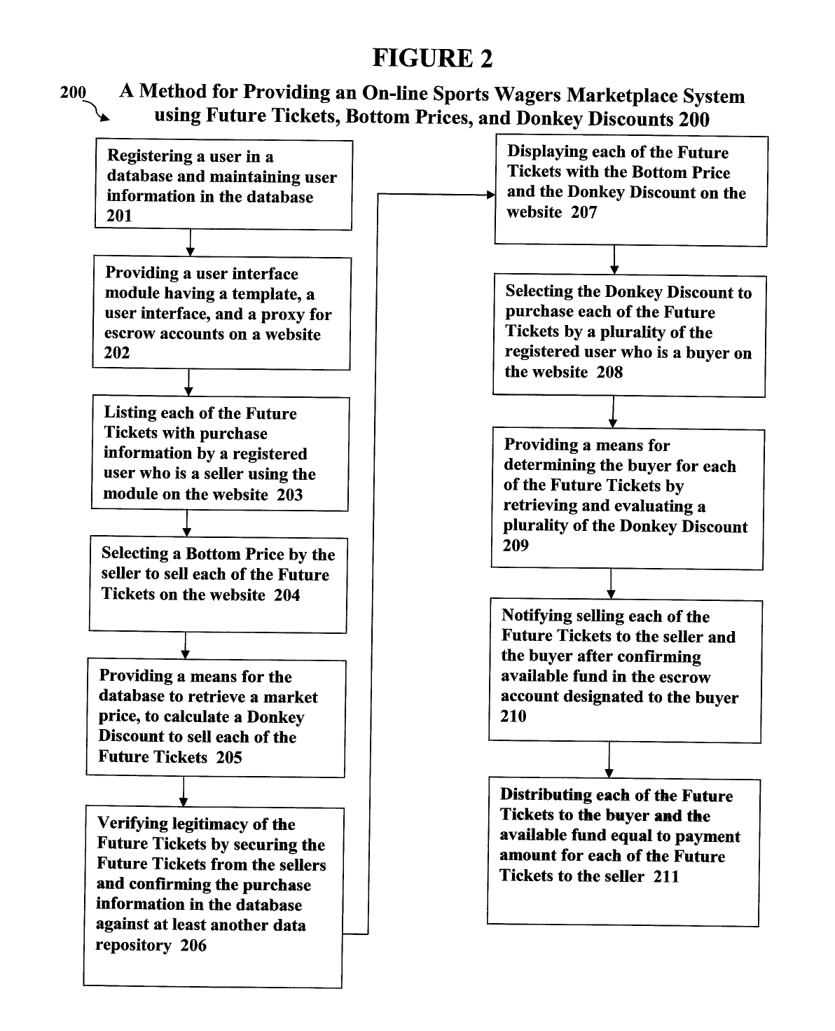

With reference in particular to FIG. 2, according to another embodiment a method for providing an on-line sports wagers marketplace system 200 comprises the following steps: registering in a database and maintaining user information in the database 201; providing a user interface module having a template, a user interface for a registered user, and a proxy for escrow accounts on a website 202 such that the website provides an intermediary marketplace for selling and buying Future Tickets wherein the Future Tickets are transferable physical tickets representing wagers on future sporting events; listing each of the Future Tickets with purchase information by a registered user who is a seller using the user interface module on the website 203; selecting a Bottom Price by the seller to sell each of the Future Tickets on the website wherein the Bottom Price is a minimum price chosen to sell at least one of the Future Tickets 204; providing a means for the database to retrieve a market price of a wager for the future sporting event from at least another data repository to calculate a Donkey Discount wherein the Donkey Discount is at least 96% of the market price and a maximum price determined to sell at least one of the Future Tickets 205; verifying legitimacy of the Future Tickets by securing the Future Tickets from the sellers and confirming the purchase information in the database against the data repository 206; displaying each of the Future Tickets with the Bottom Price and the Donkey Discount on the website 207; selecting the Donkey Discount during on-line transactions to purchase each of the Future Ticket by a plurality of the registered user who is a buyer on the website 208; providing a means for determining the buyer for each of the Future Tickets by retrieving and evaluating a plurality of the Donkey Discount 209; notifying selling each of the Future Tickets to the seller and the buyer after confirming available fund equal to payment amount for each of the Future Tickets in the escrow account designated to the buyer 210; and distributing each of the Future Tickets to the buyer and the available fund equal to payment amount for each of the Future Tickets to the seller 211.

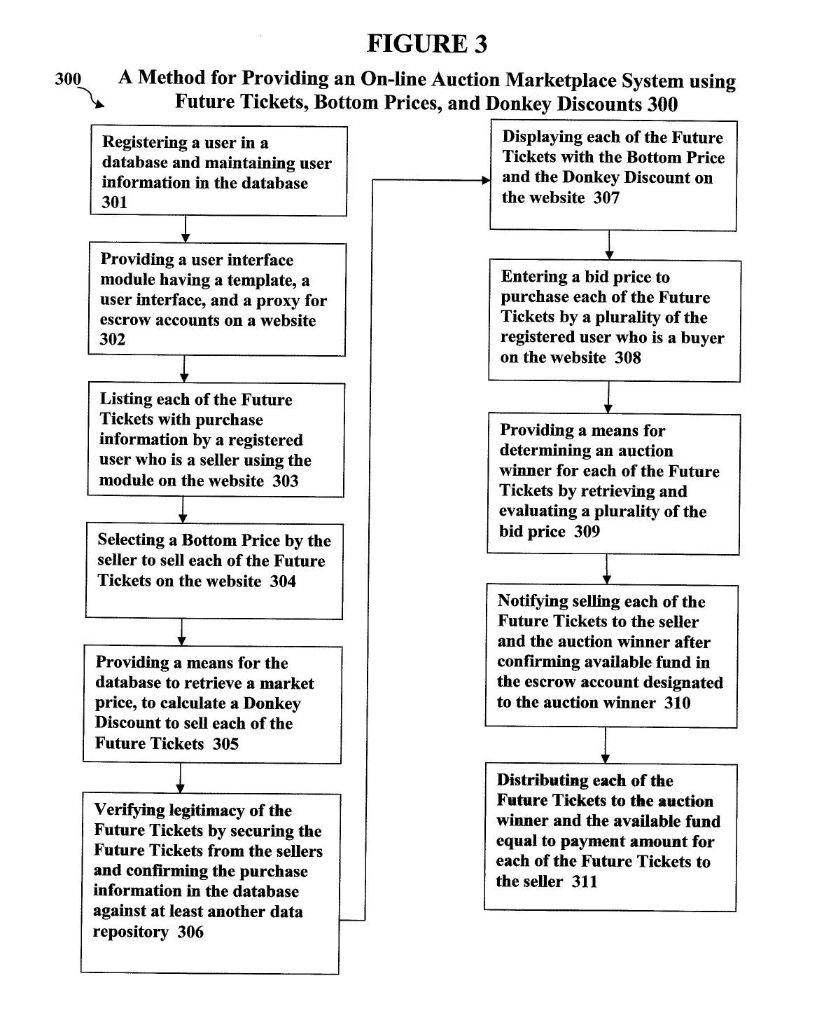

With reference to FIG. 3, according to another embodiment a method for providing an on-line auction marketplace system 300 comprises the following steps: registering in a database and maintaining user information in the database 301; providing a user interface module having a template, a user interface for a registered user, and a proxy for escrow accounts on a website 302 such that the website provides an intermediary marketplace for selling and buying Future Tickets wherein the Future Tickets are transferable physical tickets representing wagers on future sporting events; listing each of the Future Tickets with purchase information by a registered user who is a seller using the user interface module on the website 303; selecting a Bottom Price by the seller to sell each of the Future Tickets on the website wherein the Bottom Price is a minimum price chosen to sell at least one of the Future Tickets 304; providing a means for the database to retrieve a market price of a wager for the future sporting event from at least another data repository to calculate a Donkey Discount wherein the Donkey Discount is at least 96% of the market price and a maximum price determined to sell at least one of the Future Tickets 305; verifying legitimacy of the Future Tickets by securing the Future Tickets from the sellers and confirming the purchase information in the database against the data repository 306; displaying each of the Future Tickets with the Bottom Price and the Donkey Discount on the website 307; entering a bid price in an auction to purchase each of the Future Ticket by a plurality of the registered user who is a buyer on the website 308; providing a means for determining an auction winner for each of the Future Tickets by retrieving and evaluating a plurality of the bid price 309; notifying selling each of the Future Tickets to the seller and the auction winner after confirming available fund equal to payment amount for each of the Future Tickets in the escrow account designated to the auction winner 310; and distributing each of the Future Tickets to the auction winner and the available fund equal to payment amount for each of the Future Tickets to the seller 311.

In various aspects of the embodiments, an ordinary skilled person in this field of art should understand that first embodiment of the embodiments is the method for providing an on-line sports wagers marketplace system that includes selecting the Donkey Discount to purchase each of the Future Tickets by multiple registered users as described above. It shall be further understood by the ordinary skilled person in this field of art that second embodiment of the embodiments is the other method for providing an on-line auction marketplace system which includes entering the bid price in the auction to purchase each of the Future Tickets by multiple registered users at the website as described above. In certain aspects of the embodiments, the method from either first or second embodiment of the embodiments may further include providing a means for the database to retrieve a market price of a wager for the future sporting event from the data repository wherein the data repository is a sports book. Yet, in certain aspects of the embodiments, the method from either first or second embodiment of the embodiments may further comprise distributing of each of the Future Tickets to the auction winner by providing a means to hold each of the Future Tickets until a winning wager is determined for the future sporting event and to distribute a net value represented by the winning wager minus amount owed from transactions of exchanging each of the Future Tickets into the escrow account. In another aspect of the embodiments, the method from either first or second embodiment of the embodiments may further comprise auctioning for a predetermined period defined as from time each of the Future Tickets is displayed on the website for a purpose of the auctioning until a winner of the auctioning is notified, wherein the predetermined period is between 24 hours and 48 hours or until an entered price matches the Donkey Discount of each of the Future Tickets. In yet another aspect of the embodiments, the method from either first or second embodiment of the embodiments may further include registering in the database and maintaining the user information in the database wherein the database is a cloud application over Internet.

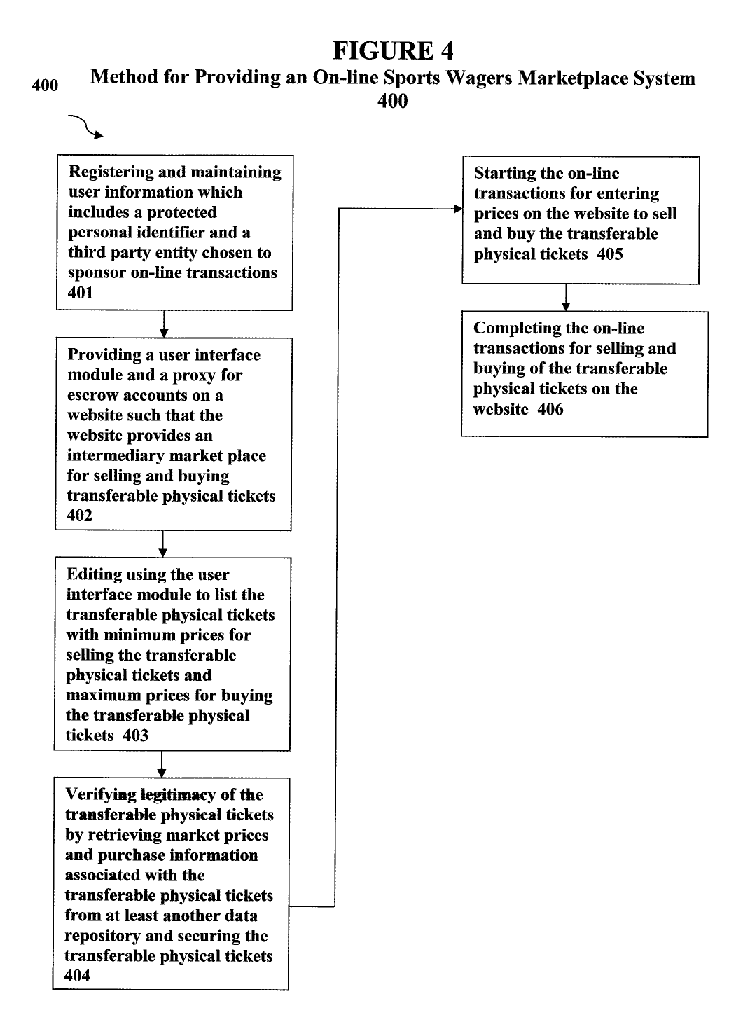

With particular reference to FIG. 4, a method for providing an on-line sports wagers marketplace system 400 comprising the following steps: registering and maintaining user information wherein the user information includes a protected personal identifier and a third party entity chosen to sponsor on-line transactions 401; providing a user interface module having a user interface for a registered user and a proxy for escrow accounts on a website such that the website provides an intermediary marketplace for selling and buying transferable physical tickets with minimum prices for selling the transferable physical tickets and maximum prices for buying the transferable physical tickets 402; editing using the user interface module to list the transferable physical tickets with minimum prices for selling the transferable physical tickets and maximum prices for buying the transferable physical tickets 403; verifying legitimacy of the transferable physical tickets by retrieving market prices and purchase information associated with the transferable physical tickets from at least another data repository and securing the transferable physical tickets 404; starting the on-line transactions for entering prices on the website to sell and buy the transferable physical tickets with the minimum prices and the maximum prices 405; and completing the on-line transactions for selling and buying of the transferable physical tickets on the website 406, wherein before the completion of the on-line transactions confirming available fund in the escrow accounts to pay for the transferable physical tickets, having evaluated a plurality of the prices entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions.

In various aspects of the embodiment, the method may further include registering and maintaining the user information which includes a preferred notification contact means. In certain aspects of the embodiment, the method further comprises registering and maintaining the user information that includes the preferred notification contact means wherein the preferred notification contact means is a mail, an expedited service mail, a certified mail, an insured mail, a telephone call, or an electronic transmission. In other aspects of the embodiment, the method may further include providing a means to enable the user interface module retrieving a plurality of data repository and servers. In certain aspects of the embodiment, the method may further comprise of providing the user interface module wherein the user interface module includes a template to list the transferable physical tickets, the minimum prices, and the maximum prices. In another aspect of the embodiment, the method may further comprise a step of auctioning for a predetermined period defined as from time at least one of the transferable physical tickets are displayed on the website for a purpose of the auctioning until a winner of the auctioning for at least one of the transferable physical tickets is notified, wherein the predetermined period is between 24 hours and 48 hours or until each of the prices matches each of the maximum prices, and wherein the on-line sports wagers marketplace is an on-line auction marketplace. In yet another aspect of the embodiment, the method may further include editing using the user interface module to list the transferable physical tickets with the minimum prices for selling the transferable physical tickets and the maximum prices for buying the transferable physical tickets, and wherein the transferable physical tickets are Future Tickets representing wagers on future sporting events, and wherein the minimum prices are Bottom Prices selected by the sellers to sell the Future Tickets, and wherein the maximum prices are Donkey Discounts and at least 96% of the market prices. In a different aspect of the embodiment, the method is further adapted for distributing of the Future Tickets to winners of the on-line auction marketplace by providing a means to hold the Future Tickets until winning wagers are determined for the future sporting events and to distribute net values represented by the winning wagers minus amount owed from transactions of exchanging the Future Tickets into the escrow accounts. In another different aspect of the embodiment, the method further includes verifying legitimacy of the transferable physical tickets wherein the registered users who enlist the transferable physical tickets in the on-line transactions by delivering the transferable physical tickets to a repository address provided on the website. In yet another aspect of the embodiment, the method may further comprise registering in the database and maintaining the user information in the database wherein the database is a cloud application over Internet.

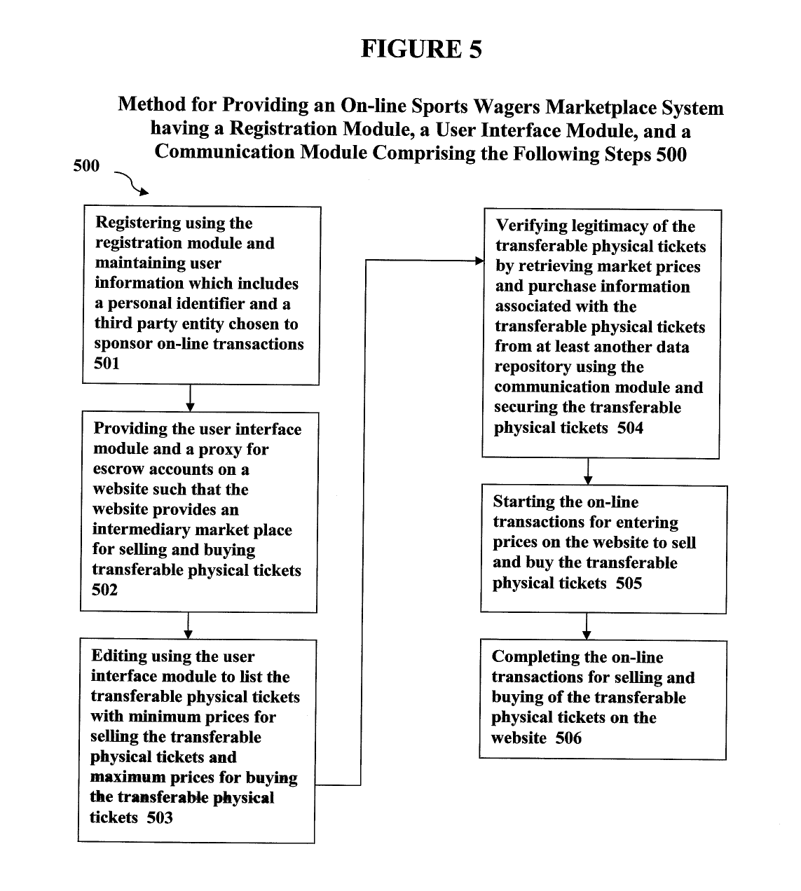

With particular reference to FIG. 5, a method of providing on-line sports wagers marketplace system having a registration module to input user information in a database and registers with the system as a registered user, a user interface module having a template, a user input interface for the registered user, and a proxy for escrow accounts on a website, and a communication module for communicating with the user interface module and one or more items from a group consisting of a user terminal, the database, a data repository, an escrow account, a server, and an algorithm module wherein the algorithm module is capable of querying, evaluating, and displaying data such that the data are communicated using the communication module comprising the following steps 500: registering using the registration module and maintaining user information wherein the user information includes a personal identifier and a third party entity chosen to sponsor on-line transactions 501; providing a user interface module having a user interface for a registered user and a proxy for escrow accounts on a website such that the website provides an intermediary marketplace for selling and buying transferable physical tickets related to future sporting events 502; editing using the user interface module to list the transferable physical tickets with minimum prices for selling the transferable physical tickets and maximum prices for buying the transferable physical tickets 503; verifying legitimacy of the transferable physical tickets by retrieving market prices and purchase information associated with the transferable physical tickets from at least another data repository using the communication module and securing the transferable physical tickets 504; starting the on-line transactions for entering prices on the website to sell and buy the transferable physical tickets with the minimum prices and the maximum prices 505; and completing the on-line transactions for selling and buying of the transferable physical tickets on the website, wherein before the completion of the on-line transactions confirming available fund in the escrow accounts to pay for the transferable physical tickets, having evaluated a plurality of the prices entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions 506.

In various aspects of the embodiment, the step of registering and maintaining the user information may further include, although not required, a preferred notification contact means. In certain aspects of the embodiment, the preferred notification contact means wherein the preferred notification contact means is a mail, an expedited service mail, a certified mail, an insured mail, a telephone call, or an electronic transmission. In other aspects of the embodiment, the method may further comprise a step of providing a means to enable the user interface module retrieving a plurality of data repository and servers. In another aspect of the embodiment, the user interface module may further include a template to list the transferable physical tickets, the minimum prices, and the maximum prices. In yet another aspect of the embodiment, the method further comprises of a step of auctioning for a predetermined period defined as from time at least one of the transferable physical tickets are displayed on the website for a purpose of the auctioning until a winner of the auctioning for at least one of the transferable physical tickets is notified, wherein the predetermined period is between 24 hours and 48 hours or until each of the prices matches each of the maximum prices, and wherein the on-line sports wagers marketplace is an on-line auction marketplace. In a different aspect of the embodiment, the method may further include a step of editing using the user interface module to list the transferable physical tickets with the minimum prices for selling the transferable physical tickets and the maximum prices for buying the transferable physical tickets, wherein the transferable physical tickets are Future Tickets representing wagers on future sporting events, and wherein the minimum prices are Bottom Prices selected by the sellers to sell the Future Tickets, and wherein the maximum prices are Donkey Discounts and at least 96% of the market prices. In certain aspects of the embodiment, the method may further comprise distributing of the Future Tickets to winners of the on-line auction marketplace by providing a means to hold the Future Tickets until winning wagers are determined for the future sporting events and to distribute net values represented by the winning wagers minus amount owed from transactions of exchanging the Future Tickets into the escrow accounts. In another aspect of the embodiment, the method may be further adapted for verifying legitimacy of the transferable physical tickets wherein the registered users who enlist the transferable physical tickets in the on-line transactions by delivering the transferable physical tickets to a repository address provided on the website. In yet another aspect of the embodiment, the method may further include registering in the database and maintaining the user information in the database wherein the database is a cloud application over Internet.

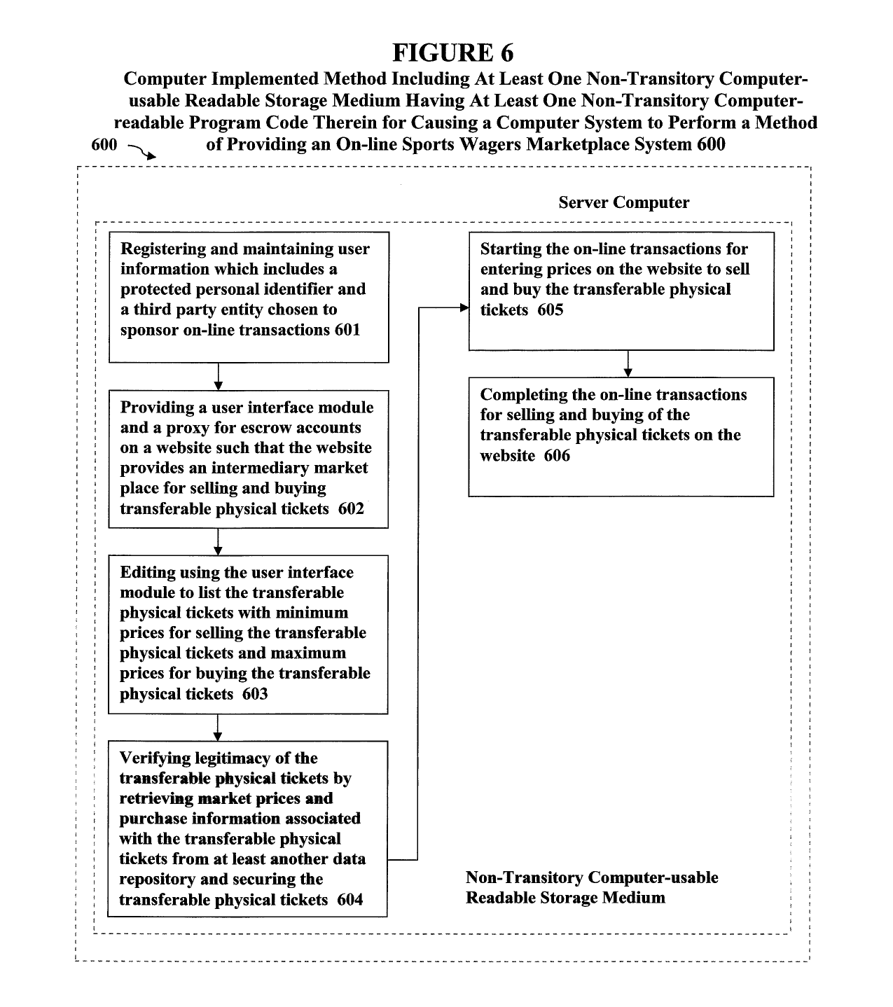

With particular reference to FIG. 6, a computer implemented method that includes at least one non-transitory computer-usable readable storage medium having at least one non-transitory computer-readable program code embodied therein for causing a computer system to perform a method of providing an on-line sports wagers marketplace system 600 as following: registering and maintaining user information wherein the user information includes a protected personal identifier and a third party entity chosen to sponsor on-line transactions 601; providing a user interface module having a user interface for a registered user and a proxy for escrow accounts on a website such that the website provides an intermediary marketplace for selling and buying transferable physical tickets related to future sporting events 602; editing using the user interface module to list the transferable physical tickets with minimum prices for selling the transferable physical tickets and maximum prices for buying the transferable physical tickets 603; verifying legitimacy of the transferable physical tickets by retrieving market prices and purchase information associated with the transferable physical tickets from at least another data repository and securing the transferable physical tickets 604; starting the on-line transactions for entering prices on the website to sell and buy the transferable physical tickets with the minimum prices and the maximum prices 605; and completing the on-line transactions for bidding on the transferable physical tickets on the website 606, wherein before the completion of the on-line transactions confirming available fund in the escrow accounts to pay for the transferable physical tickets, having evaluated a plurality of the prices entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions.

In various aspects of the embodiment, the computer implemented method may further comprise of registering and maintaining the user information wherein the user information includes a preferred notification contact means. In certain aspects of the embodiment, the computer implemented method further includes registering and maintaining the user information includes the preferred notification contact means wherein the preferred notification contact means is a mail, an expedited service mail, a certified mail, an insured mail, a telephone call, or an electronic transmission. In other aspects of the embodiment, the computer implemented method may further comprise a step of providing a means to enable the user interface module adapted for retrieving a plurality of data repository and servers. In another aspect of the embodiment, the computer implemented method may further include a template to list the transferable physical tickets, the minimum prices, and the maximum prices. In a particular aspect of the embodiment, the method further includes a step for auctioning for a predetermined period defined as from time at least one of the transferable physical tickets are displayed on the website for a purpose of the auctioning until a winner of the auctioning for at least one of the transferable physical tickets is notified, wherein the predetermined period is between 24 hours and 48 hours or until each of the prices matches each of the maximum prices, and wherein the on-line sports wagers marketplace is an on-line auction marketplace. In yet another aspect of the embodiment, the computer implemented method may further comprise editing using the user interface module to list the transferable physical tickets with the minimum prices for selling the transferable physical tickets and the maximum prices for buying the transferable physical tickets, wherein the transferable physical tickets are Future Tickets representing wagers on future sporting events, and wherein the minimum prices are Bottom Prices selected by the sellers to sell the Future Tickets, and wherein the maximum prices are Donkey Discounts and at least 96% of the market prices. In certain aspects of the embodiment, the computer implemented method further comprises distributing of the Future Tickets to winners of the on-line auction marketplace by providing a means to hold the Future Tickets until winning wagers are determined for the future sporting events and to distribute net values represented by the winning wagers minus amount owed from transactions of exchanging the Future Tickets into the escrow accounts. In a different aspect of the embodiment, the computer implemented method further includes verifying legitimacy of the transferable physical tickets wherein the registered users who enlist the transferable physical tickets in the on-line transactions by delivering the transferable physical tickets to a repository address provided on the website. In yet another aspect of the embodiment, the computer implemented method may further comprises registering in the database and maintaining the user information in the database wherein the database is a cloud application over Internet.

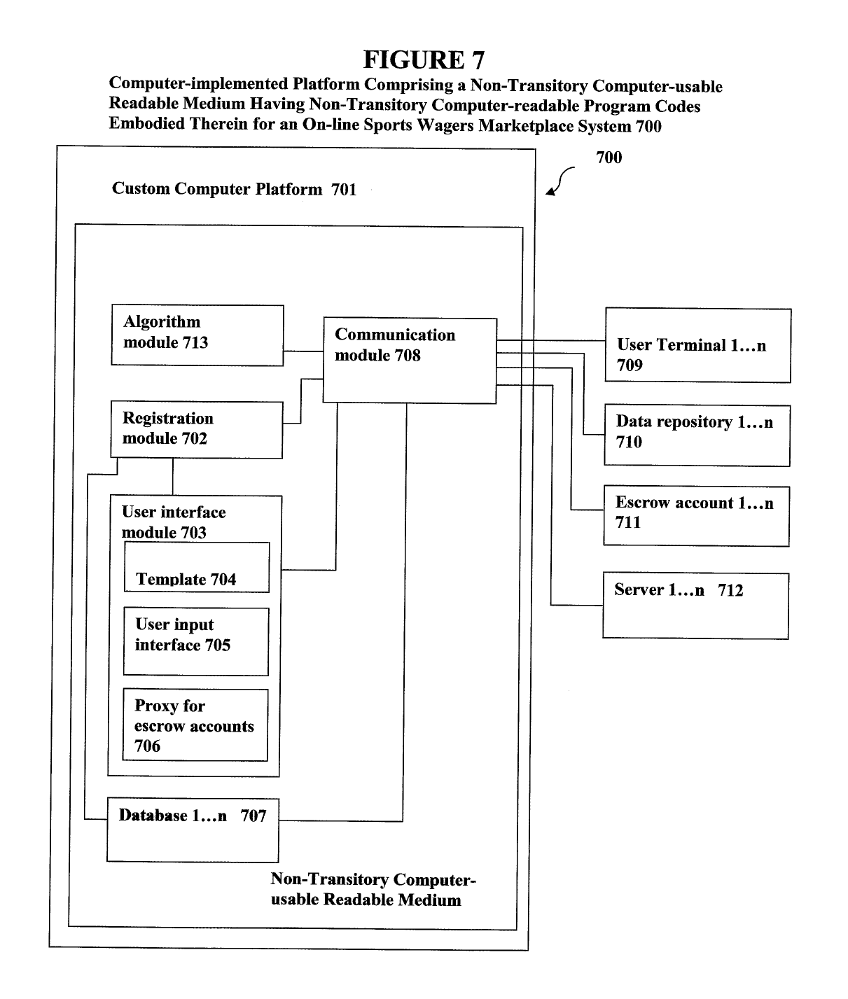

With particular reference to FIG. 7, a computer-implemented platform comprising a non-transitory computer-usable readable storage medium having non-transitory computer-readable program codes embodied therein for causing an on-line sports wagers marketplace system computer system 700 to perform steps in exchanging transferable physical tickets related to future sporting events comprises a custom computer platform 701; a registration module 702 to input user information, wherein the user information includes a preferred notification contact means, and to register with the on-line sports wagers marketplace system as a registered user; a user interface module 703 having a template 704 and a user input interface 705 for the registered user to register with the on-line sports wagers marketplace system, and a proxy for escrow accounts 706 on a website, and wherein the website provides an intermediary marketplace for selling and buying transferable physical tickets related to future sporting events, and wherein the user input interface allowing to enter one or more inputs selected from a group consisting of protected login, numeric, alphanumeric, image, audio, video, hyperlink, and text entries, and wherein the proxy for escrow accounts allows to confirm, secure, and transfer available fund in the escrow accounts in conjunction with transactions involving selling and buying the transferable physical tickets; a database 707 for storing the user information for the registered user, wherein the user information is identified to the registered user and enabled for querying, evaluating, and displaying; and a communication module 708 for communicating with the user interface module and one or more items from a group consisting of a user terminal 709, the database, a data repository 710, an escrow account 711, a server 712, and an algorithm module 713, wherein the algorithm module is capable of querying, evaluating, and displaying data such that the data are communicated using the communication module.

In various aspects of the embodiment, the computer-implemented platform may include the registration module that further comprises of one or more preferred notification contact means from a group consisting of a mail, an expedited service mail, a certified mail, an insured mail, a telephone call, or an electronic transmission in the user information. In other aspects of the embodiment, the computer-implemented platform may further include a feature within the user interface module that is adapted to further allow the registered user to designate the communication module and the algorithm module authorized to access the user information, the database, and the escrow accounts related to on-line sports wagers marketplace transactions by the registered user, wherein the communication module and the algorithm module are adapted to further allow verification of data, transfer of funds in the escrow accounts, and display a transaction status related to the on-line sports wagers marketplace transactions by the registered user. In a particular aspect of the embodiment, the computer-implemented platform may further comprise, although not required, the template having selection and displays of the transferable physical tickets, minimum prices chosen to sell the transferable physical tickets, maximum prices determined by the algorithm module to sell the transferable physical tickets, and buyers determined by the algorithm module to successfully purchase the transferable physical tickets. In yet another particular aspect of the embodiment, the computer-implemented platform may be further enabled to cause the on-line sports wagers marketplace system to be an on-line auction marketplace system that further provides auctioning of said transferable physical tickets.

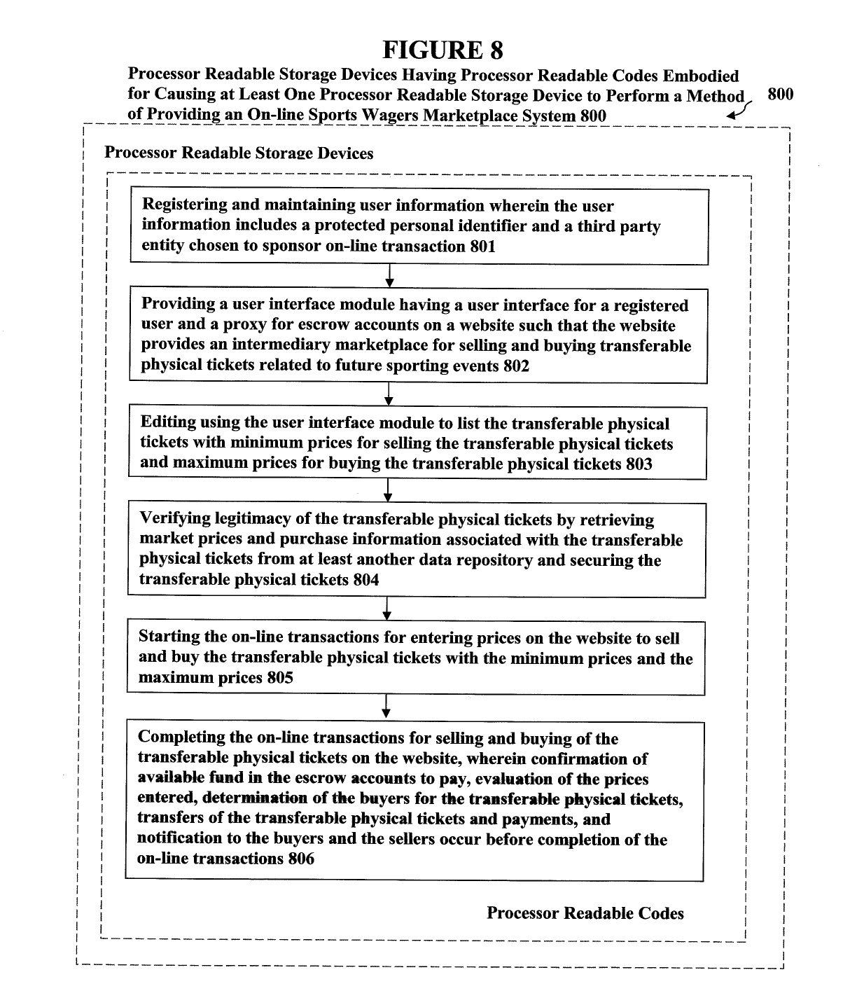

With particular reference to FIG. 8 according to another embodiment, one or more processor readable storage devices, which include processor readable codes embodied on at least one processor readable storage device, and at least one processor programmed by the processor readable codes to perform a method of providing an on-line sports wagers marketplace system 800 comprising steps of registering and maintaining user information wherein the user information includes a protected personal identifier and a third party entity chosen to sponsor on-line transactions 801; providing a user interface module having a user interface for a registered user and a proxy for escrow accounts on a website such that the website provides an intermediary marketplace for selling and buying transferable physical tickets related to future sporting events 802; editing using the user interface module to list the transferable physical tickets with minimum prices for selling the transferable physical tickets and maximum prices for buying the transferable physical tickets 803; verifying legitimacy of the transferable physical tickets by retrieving market prices and purchase information associated with the transferable physical tickets from at least another data repository and securing the transferable physical tickets 804; starting the on-line transactions for entering prices on the website to sell and buy the transferable physical tickets with the minimum prices and the maximum prices 805; and completing the on-line transactions for selling and buying of the transferable physical tickets on the website, wherein before the completion of the on-line transactions confirming available fund in the escrow accounts to pay for the transferable physical tickets, having evaluated a plurality of the bids entered and determined buyers for the transferable physical tickets, transferring of the transferable physical tickets from the sellers' escrow accounts to the buyers' escrow accounts and payments from the buyers' escrow accounts to the sellers' escrow accounts, and notifying the buyers and the sellers of the on-line transactions 806.

In various aspects of the embodiment, the one or more processor readable storage devices and at least one processor programmed by the processor readable codes are further adapted to perform the method that may further comprise registering and maintaining the user information wherein the user information includes a preferred notification contact means. In other aspects of the embodiment, another further adaption enables performing the method which may include registering and maintaining the user information includes the preferred notification contact means wherein the preferred notification contact means is a mail, an expedited service mail, a certified mail, an insured mail, a telephone call, or an electronic transmission. In certain aspects of the embodiment, the method may further comprise providing a means to enable the user interface module that is capable of retrieving multiple data repository and servers. In a particular aspect of the embodiment, the method further includes providing the user interface module wherein the user interface module having a template to list the transferable physical tickets, the minimum prices, and the maximum prices. In a different aspect of the embodiment, the method may further comprise a step of auctioning for a predetermined period defined as from time at least one of the transferable physical tickets are displayed on the website for a purpose of the auctioning until a winner of the auctioning for at least one of the transferable physical tickets is notified, wherein the predetermined period is between 24 hours and 48 hours or until each of the prices matches each of the maximum prices, and wherein the on-line sports wagers marketplace is an on-line auction marketplace. In another aspect of the embodiment, the one or more processor readable storage devices and at least one processor programmed by the processor readable codes further include a feature to perform the method that may further comprise editing using the user interface module to list the transferable physical tickets with the minimum prices for selling the transferable physical tickets and the maximum prices for buying the transferable physical tickets, wherein the transferable physical tickets are Future Tickets representing wagers on future sporting events, and wherein the minimum prices are Bottom Prices selected by the sellers to sell the Future Tickets, and wherein the maximum prices are Donkey Discounts and at least 96% of the market prices. In yet another aspect of the embodiment, the method may further comprise distributing of the Future Tickets to winners of the on-line auction marketplace by providing a means to hold the Future Tickets until winning wagers are determined for the future sporting events and to distribute net values represented by the winning wagers minus amount owed from transactions of exchanging the Future Tickets into the escrow accounts. In certain aspects of the embodiment, the method further comprises of verifying legitimacy of the transferable physical tickets wherein the registered users who enlist the transferable physical tickets in the on-line transactions by delivering the transferable physical tickets to a repository address provided on the website. In yet another aspect of the embodiment, the method is further allowed for registering in the database and maintaining the user information in the database wherein the database is a cloud application over Internet.

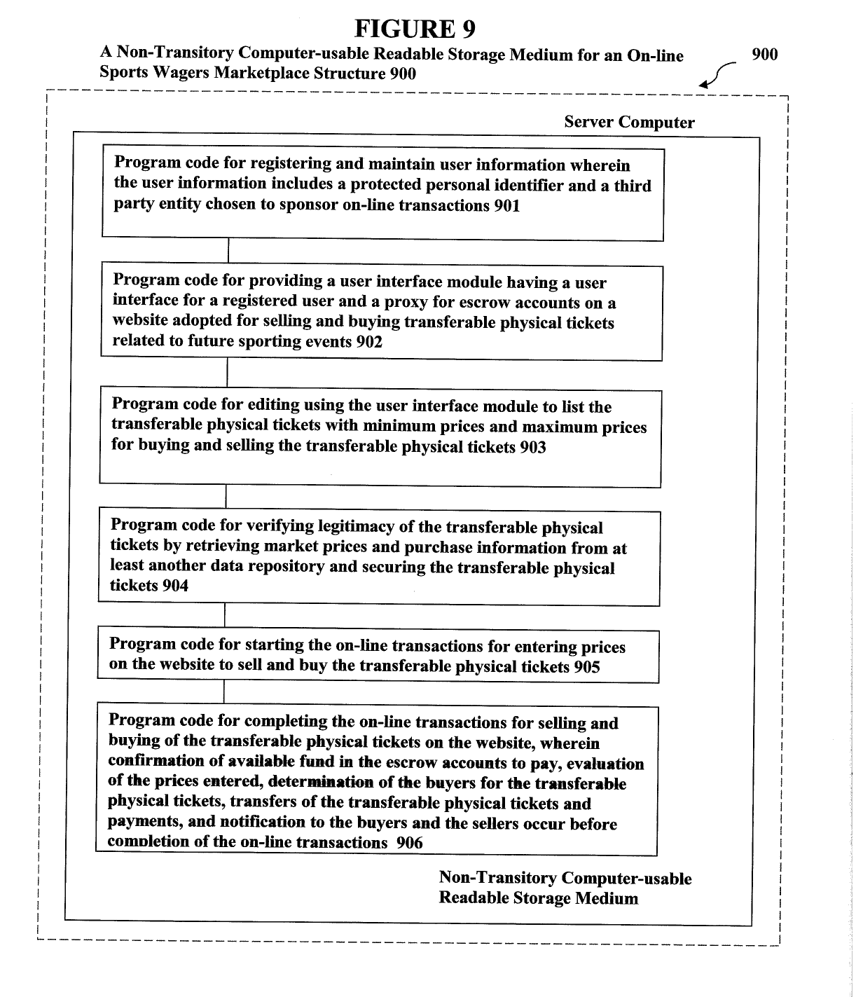

With particular reference to FIG. 9, a non-transitory computer-usable readable storage medium for an on-line sports wagers marketplace structure 900 comprises (a) program code for registering and maintaining user information wherein the user information includes a protected personal identifier and a third party entity chosen to sponsor on-line transactions 901; (b) program code for providing a user interface module having a user interface for a registered user and a proxy for escrow accounts on a website such that the website provides an intermediary marketplace for selling and buying transferable physical tickets related to future sporting events 902; (c) program code for editing using the user interface module to list the transferable physical tickets with minimum prices for selling the transferable physical tickets and maximum prices for buying the transferable physical tickets 903; (d) program code for verifying legitimacy of the transferable physical tickets by retrieving market prices and purchase information associated with the transferable physical tickets from at least another data repository and securing the transferable physical tickets 904; (e) program code for starting the on-line transactions for entering prices on the website to sell and buy the transferable physical tickets 905 with the minimum prices and maximum prices; and (f) program code for completing the on-line transactions for selling and buying of the transferable physical tickets on the website, wherein before the completion of the on-line transactions confirming available fund in the escrow accounts to pay for the transferable physical tickets, having evaluated a plurality of the bids entered and determined buyers for the transferable physical tickets, transferring of the transferable physical tickets from the sellers' escrow accounts to the buyers' escrow and payments from the buyers' escrow accounts to the sellers' escrow accounts, and notifying the buyers and the sellers of the on-line transactions 906.

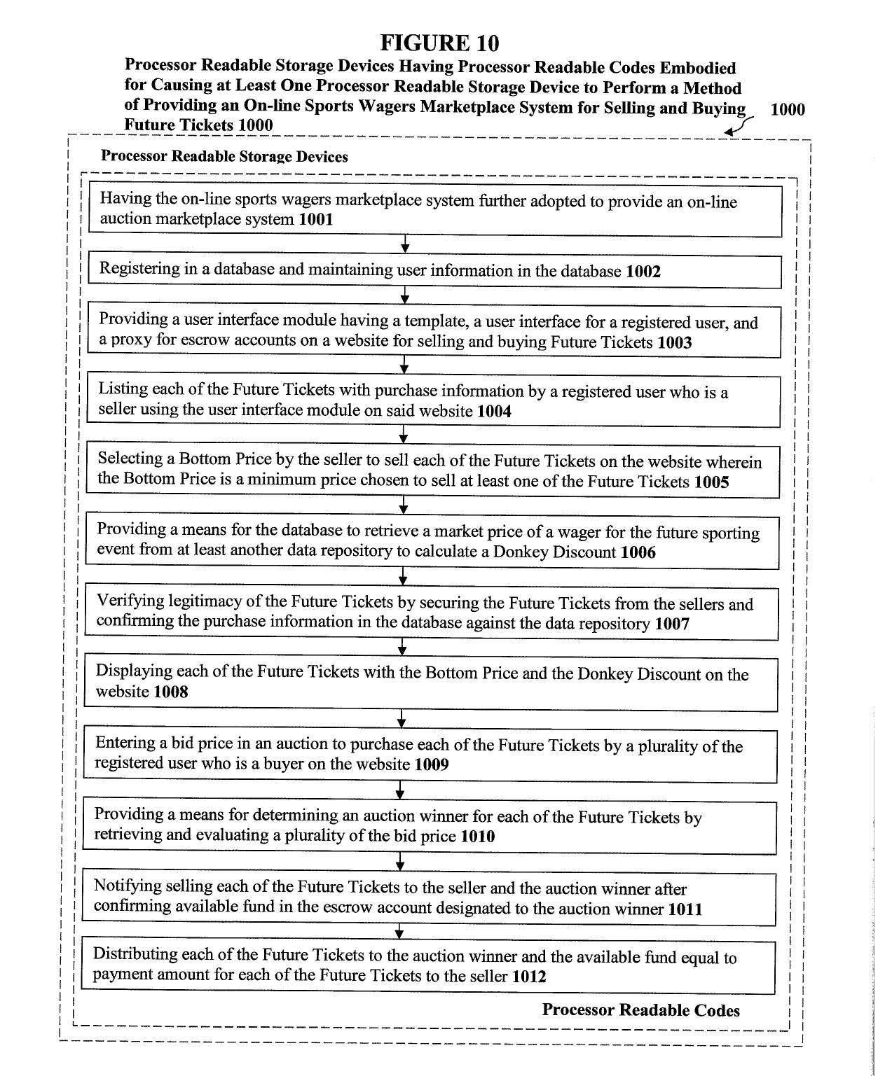

With particular reference to FIG. 10, at least one or more processor readable storage devices, which have processor readable codes embodied, are caused by the process readable codes to perform a method of providing an on-line sports wagers marketplace system for selling and buying Future Tickets 1000 including steps for having the on-line sports wagers marketplace system further adopted to provide an on-line auction marketplace system 1001; registering in a database and maintaining user information in the database 1002; providing a user interface module having a template, a user interface for a registered user, and a proxy for escrow accounts on a website such that the website provides an intermediary marketplace for selling and buying Future Tickets wherein the Future Tickets are transferable physical tickets representing wagers on future sporting events 1003; listing each of the Future Tickets with purchase information by a registered user who is a seller using the user interface module on the website 1004; selecting a Bottom Price by the seller to sell each of the Future Tickets on the website wherein the Bottom Price is a minimum price chosen to sell at least one of the Future Tickets 1005; providing a means for the database to retrieve a market price of a wager for the future sporting event from at least another data repository to calculate a Donkey Discount wherein the Donkey Discount is at least 96% of the market price and a maximum price determined to sell at least one of the Future Tickets 1006; verifying legitimacy of the Future Tickets by securing the Future Tickets from the sellers and confirming the purchase information in the database against the data repository 1007; displaying each of the Future Tickets with the Bottom Price and the Donkey Discount on the website 1008; entering a bid price in an auction to purchase each of the Future Tickets by a plurality of the registered user who is a buyer on the website 1009; providing a means for determining an auction winner for each of the Future Tickets by retrieving and evaluating a plurality of the bid price 1010; notifying selling each of the Future Tickets to the seller and the auction winner after confirming available funds equal to payment amount for each of the Future Tickets in the escrow account designated to the auction winner 1011; and distributing each of the Future Tickets to the auction winner and the available fund equal to payment amount for each of the Future Tickets to the seller 1012.

In various aspects of the embodiment, at least one or more of the processor readable storage devices are further adapted for performing the method that may further include providing a means for the database to retrieve a market price of a wager for the future sporting event from the data repository wherein the data repository is a sports book. In other aspects of the embodiment, the method further includes distributing each of the Future Tickets to the auction winner by providing a means to hold each of the Future Tickets until a winning wager is determined for the future sporting event and to distribute a net value represented by the winning wager minus amount owed from transactions of exchanging each of the Future Tickets into the escrow account. In a particular aspect of the embodiment, the method may further comprise running the auction for a predetermined period defined as from time each of the Future Tickets is displayed on the website for a purpose of the auction until the auction winner is notified, wherein the predetermined period is between 24 hours and 48 hours or until the bid price matches the Donkey Discount of each of the Future Tickets. In yet another aspect of the embodiment, the method may further include registering in the database and maintaining the user information in the database wherein the database is a cloud application over Internet.

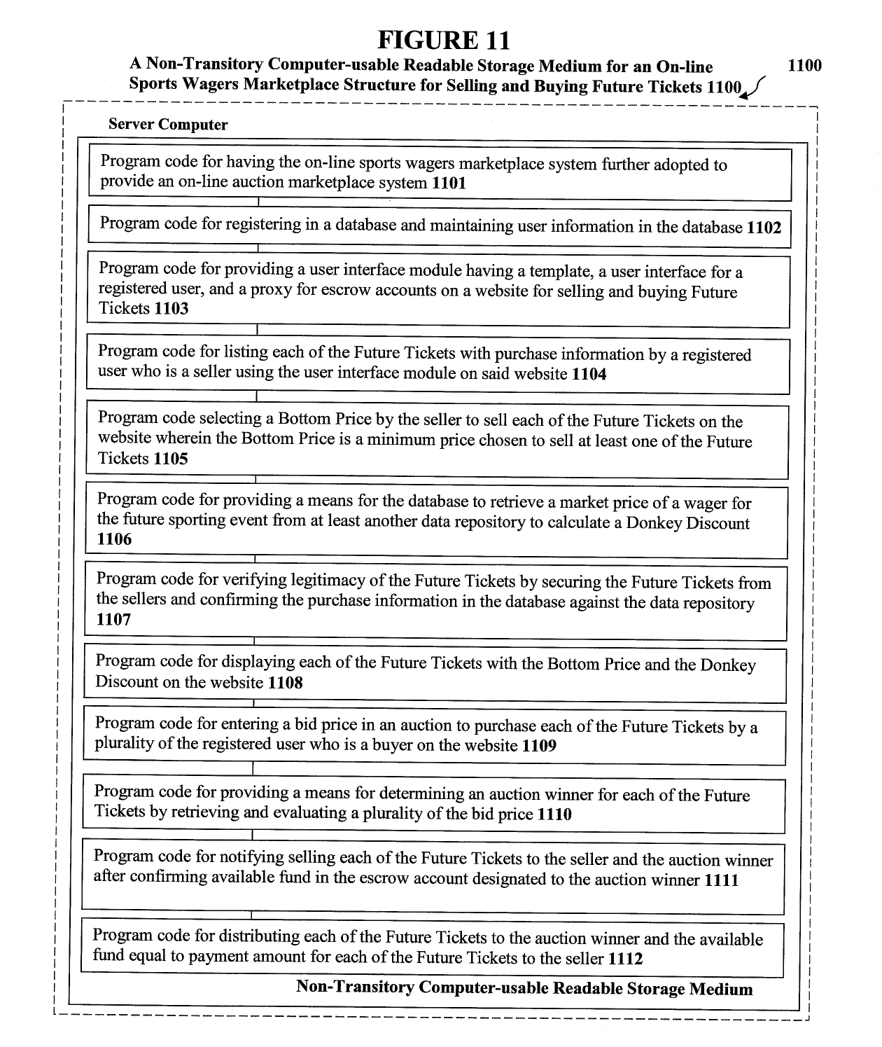

With reference to FIG. 11, a non-transitory computer-usable readable storage medium for an on-line sports wagers marketplace structure for selling and buying Future Tickets 1100 includes (a) program code for having the on-line sports wagers marketplace system further adopted to provide an on-line auction marketplace system 1101; (b) program code for registering in a database and maintaining user information in the database 1102; (c) program code for providing a user interface module that has a template, a user interface for a registered user, and a proxy for escrow accounts on a website which provides an intermediary marketplace for selling and buying Future Tickets wherein the Future Tickets are transferable physical tickets representing wagers on future sporting events 1103; (d) program code for listing each of the Future Tickets with purchase information by a registered user who is a seller using the user interface module on the website 1104; (e) program code for selecting a Bottom Price by the seller to sell each of the Future Tickets on the website wherein the Bottom Price is a minimum price chosen to sell at least one of the Future Tickets 1105; (f) program code for providing a means for the database to retrieve a market price of a wager for the future sporting event from at least another data repository to calculate a Donkey Discount wherein the Donkey Discount is at least 96% of the market price and a maximum price determined to sell at least one of the Future Tickets 1106; (g) program code for verifying legitimacy of the Future Tickets by securing the Future Tickets from sellers and confirming the purchase information in the database against the data repository 1107; (h) program code for displaying each of the Future Tickets with the Bottom Price and the Donkey Discount on the website 1108; (i) program code for entering a bid price in an auction to purchase each of the Future Tickets by a plurality of the registered user who is a buyer on the website 1109; (j) program code for providing a means for determining an auction winner for each of the Future Tickets by retrieving and evaluating a plurality of the bid price 1110; (k) program code for notifying selling each of the Future Tickets to the seller and the auction winner after confirming available fund equal to payment amount for each of the Future Tickets in the escrow account designated to the auction winner 1111; and (l) program code for distributing each of the Future Tickets to the auction winner and the available fund equal to payment amount for each of the Future Tickets to the seller 1112.

In the following examples, an exemplary on-line auction marketplace system operated to further illustrate the operating principles of the current invention.

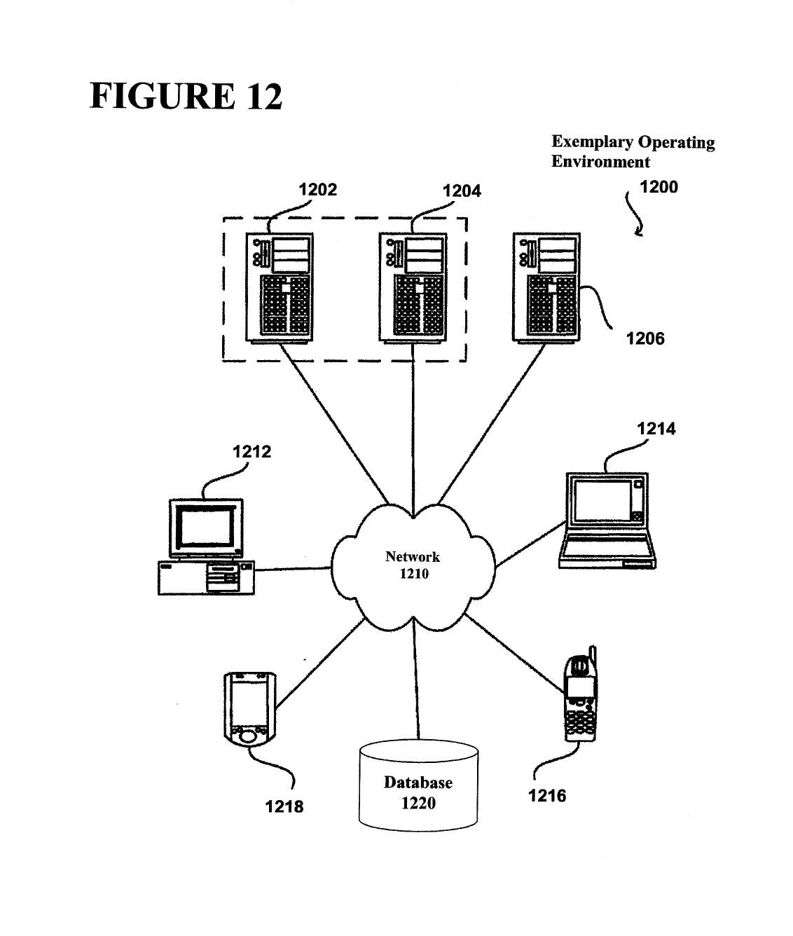

FIG. 12 is a block diagram illustrating components of an exemplary operating environment in which embodiments of the present invention may be implemented. The system 1200 can include one or more user computers, computing devices, or processing devices 1212, 1214, 1216, 1218, which can be used to operate a client, such as a dedicated application, web browser, etc. The user computers 1212, 1214, 1216, 1218 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 1212, 1214, 1216, 1218 may also have any of a variety of applications, including one or more development systems, database client and/or server applications, and Web browser applications. Alternatively, the user computers 1212, 1214, 1216, 1218 may be any other electronic device, such as a thin-client computer, Internet-enabled gaming system, and/or personal messaging device, capable of communicating via a network (e.g., the network 1210 described below) and/or displaying and navigating Web pages or other types of electronic documents. Although the exemplary system 1200 is shown with four user computers, any number of user computers may be supported.

In most embodiments, the system 1200 includes some type of network 1210. The network can be any type of network familiar to those skilled in the art that can support data communications using any of a variety of commercially-available protocols, including without limitation TCP/IP, SNA, IPX, AppleTalk, and the like. Merely by way of example, the network 1210 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 1202, 1204, 1206 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 1206) may be dedicated to running applications, such as a business application, a Web server, application server, etc. Such servers may be used to process requests from user computers 1212, 1214, 1216, 1218. The applications can also include any number of applications for controlling access to resources of the servers 1202, 1204, 1206.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1212, 1214, 1216, 1218. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 1212, 1214, 1216, 1218.

The system 1200 may also include one or more databases 1220. The database(s) 1220 may reside in a variety of locations. By way of example, a database 1220 may reside on a storage medium local to (and/or resident in) one or more of the computers 1202, 1204, 1206, 1212, 1214, 1216, 1218. Alternatively, it may be remote from any or all of the computers 1202, 1204, 1206, 1212, 1214, 1216, 1218, and/or in communication (e.g., via the network 1210) with one or more of these. In a particular set of embodiments, the database 1220 may reside in a storage-area network (“SAN”) familiar to those skilled in the art. Similarly, any necessary files for performing the functions attributed to the computers 1202, 1204, 1206, 1212, 1214, 1216, 1218 may be stored locally on the respective computer and/or remotely, as appropriate. In one set of embodiments, the database 1220 may be a relational database, such as Oracle 10g, that is adapted to store, update, and retrieve data in response to SQL-formatted commands.

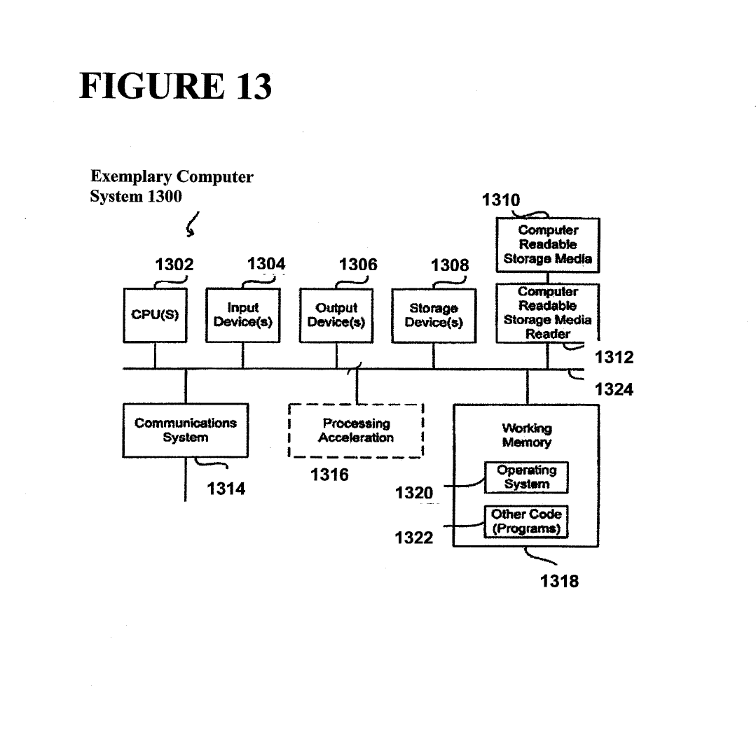

FIG. 13 illustrates an exemplary computer system 1300, in which embodiments of the present invention may be implemented. The system 1300 may be used to implement any of the computer systems described above. The computer system 1300 is shown comprising hardware elements that may be electrically coupled via a bus 1324. The hardware elements may include one or more central processing units (CPUs) 1302, one or more input devices 1304 (e.g., a mouse, a keyboard, etc.), and one or more output devices 1306 (e.g., a display device, a printer, etc.). The computer system 1300 may also include one or more storage devices 1308. By way of example, the storage device(s) 1308 can include devices such as disk drives, optical storage devices, solid-state storage device such as a random access memory (“RAM”) and/or a read-only memory (“ROM”), which can be programmable, flash-updateable and/or the like.

The computer system 1300 may additionally include a non-transitory computer-readable storage media reader 1312, a communications system 1314 (e.g., a modem, a network card (wireless or wired), an infra-red communication device, etc.), and working memory 1318, which may include RAM and ROM devices as described above. In some embodiments, the computer system 1300 may also include a processing acceleration unit 1316, which can include a digital signal processor DSP, a special-purpose processor, and/or the like.

The non-transitory computer-readable storage media reader 1312 can further be connected to a non-transitory computer-readable storage medium 1310, together (and, optionally, in combination with storage device(s) 1308) comprehensively representing remote, local, fixed, and/or removable storage devices plus storage media for temporarily and/or more permanently containing, storing, transmitting, and retrieving non-transitory computer-readable information. The communications system 1314 may permit data to be exchanged with the network and/or any other computer described above with respect to the system 1300.

The computer system 1300 may also comprise software elements, shown as being currently located within a working memory 1318, including an operating system 1320 and/or other code 1322, such as an application program (which may be a client application, Web browser, mid-tier application, RDBMS, etc.). It should be appreciated that alternate embodiments of a computer system 1300 may have numerous variations from that described above. For example, customized hardware might also be used and/or particular elements might be implemented in hardware, software (including portable software, such as applets), or both. Further, connection to other computing devices such as network input/output devices may be employed.

Storage media and non-transitory computer readable media for containing code, or portions of code, can include any appropriate media known or used in the art, including storage media and communication media, such as but not limited to volatile and non-volatile, removable and non-removable media implemented in any method or technology for storage and/or transmission of information such as non-transitory computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 13 further illustrates an environment where an on-demand distributed database service might be used. As illustrated in FIG. 13 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a non-transitory machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

The above illustrations provide many different embodiments for implementing different features of the invention. Specific embodiments of components and processes are described to help clarify the invention. These are, of course, merely embodiments and are not intended to limit the invention from that described in the claims.

An exemplary application platform peer to peer network includes an application setup mechanism that supports application developers' creation and management of applications, which may be saved as metadata into a database by save routines for execution by subscribers as one or more processes managed by distributed database management processes for example. Invocations to such applications may be coded using PL/SOQL that provides a programming language style interface extension to an application programming interface API or other suitable programming languages. Invocations to applications may be detected by one or more system processes which manage retrieval of application metadata for the subscriber making the invocation and executing the metadata as an application in a virtual machine.

It should also be understood that each application server may be communicably coupled to one or more distributed database systems, e.g., system database and multi-enterprise database(s), via a different network connection to form a peer to peer network. For example, one server might be coupled via the Internet, another server might be coupled via a direct network link, and another server might be coupled by yet a different network connection. Transfer Control Protocol and Internet Protocol (TCP/IP) are typical protocols for communicating between servers and one or more distributed database systems. However, it will be apparent to one skilled in the art that other transport protocols may be used to optimize the system depending on the network interconnect used to implement the peer to peer, distributed network.

Each of the one or more distributed database systems can generally be viewed as a collection of objects, such as a set of logical tables, containing data fitted into predefined categories. A “table” is one representation of a data object, and is used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields.

Although illustrative embodiments have been described herein, it should be understood and will be appreciated by those skilled in the art that numerous variations may be made or applied within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

What is claimed is:

1. An on-line sports wagers marketplace system comprising:
a registration module to input user information in a database and to register with said on-line sports wagers marketplace system as a registered user;
a user interface module having a template, a user input interface for said registered user to register with said on-line sports wagers marketplace system, and a proxy for escrow accounts on a website, wherein said website provides an intermediary marketplace for selling and buying transferable physical tickets related to future sporting events, and wherein said user input interface allowing to enter one or more inputs selected from a group consisting of protected login, numeric, alphanumeric, image, audio, video, hyperlink, and text entries, and wherein said proxy for escrow accounts allows to confirm, secure, and transfer available fund in said escrow accounts in conjunction with transactions involving selling and buying said transferable physical tickets; and
a communication module for communicating with said user interface module and one or more items from a group consisting of a user terminal, said database, a data repository, an escrow account, a server, and an algorithm module, wherein said algorithm module is capable of querying, evaluating, and displaying data such that said data are communicated using said communication module.

2. The on-line sports wagers marketplace system of claim 1, wherein said registration module further comprises of a preferred notification contact means in said user information.

3. The on-line sports wagers marketplace system of claim 2, wherein said registration module further comprises of one or more preferred notification contact means from a group consisting of a mail, an expedited service mail, a certified mail, an insured mail, a telephone call, or an electronic transmission in said user information.

4. The on-line sports wagers marketplace system of claim 3, wherein said user interface module is adapted to further allow said registered user to designate said communication module and said algorithm module authorized to access said user information, said database, and said escrow accounts related to on-line sports wagers marketplace transactions by said registered user, wherein said communication module and said algorithm module are adapted to further allow verification of data, transfer of funds in said escrow accounts, and display a transaction status related to said on-line sports wagers marketplace transactions by said registered user.

5. The on-line sports wagers marketplace system of claim 4, wherein said template further comprises of selection and displays of said transferable physical tickets, minimum prices chosen to sell said transferable physical tickets, maximum prices determined by said algorithm module to sell said transferable physical tickets, and buyers determined by said algorithm module to successfully purchase said transferable physical tickets.

6. The on-line sports wagers marketplace system of claim 5, wherein said on-line sports wagers marketplace system is an on-line auction marketplace system that further provides auctioning of said transferable physical tickets.

7. A method for providing an on-line sports wagers marketplace system comprising the following steps:
registering in a database and maintaining user information in said database;
providing a user interface module having a template, a user interface for a registered user, and a proxy for escrow accounts on a website such that said website provides an intermediary marketplace for selling and buying Future Tickets wherein said Future Tickets are transferable physical tickets representing wagers on future sporting events;
listing each of said Future Tickets with purchase information by a registered user who is a seller using said user interface module on said website;
selecting a Bottom Price by said seller to sell each of said Future Tickets on said website wherein said Bottom Price is a minimum price chosen to sell at least one of said Future Tickets;
providing a means for said database to retrieve a market price of a wager for said future sporting event from at least another data repository to calculate a Donkey Discount wherein said Donkey Discount is at least 96% of said market price and a maximum price determined to sell at least one of said Future Tickets;
verifying legitimacy of said Future Tickets by securing said Future Tickets from said sellers and confirming said purchase information in said database against said data repository;
displaying each of said Future Tickets with said Bottom Price and said Donkey Discount on said website;
selecting said Donkey Discount to purchase each of said Future Tickets by a plurality of said registered user who is a buyer on said website;
providing a means for determining said buyer for each of said Future Tickets by retrieving and evaluating a plurality of said Donkey Discount;
notifying selling each of said Future Tickets to said seller and said buyer after confirming available fund equal to payment amount for each of said Future Tickets in said escrow account designated to said buyer; and
distributing each of said Future Tickets to said buyer and said available fund equal to payment amount for each of said Future Tickets to said seller.

8. A method for providing an on-line auction marketplace system comprising the following steps:
registering in a database and maintaining user information in said database;
providing a user interface module having a template, a user interface for a registered user, and a proxy for escrow accounts on a website such that said website provides an intermediary marketplace for selling and buying Future Tickets wherein said Future Tickets are transferable physical tickets representing wagers on future sporting events;
listing each of said Future Tickets with purchase information by a registered user who is a seller using said user interface module on said website;
selecting a Bottom Price by said seller to sell each of said Future Tickets on said website wherein said Bottom Price is a minimum price chosen to sell at least one of said Future Tickets;
providing a means for said database to retrieve a market price of a wager for said future sporting event from at least another data repository to calculate a Donkey Discount wherein said Donkey Discount is at least 96% of said market price and a maximum price determined to sell at least one of said Future Tickets;
verifying legitimacy of said Future Tickets by securing said Future Tickets from said sellers and confirming said purchase information in said database against said data repository;
displaying each of said Future Tickets with said Bottom Price and said Donkey Discount on said website;
entering a bid price in an auction to purchase each of said Future Tickets by a plurality of said registered user who is a buyer on said website;
providing a means for determining an auction winner for each of said Future Tickets by retrieving and evaluating a plurality of said bid price;
notifying selling each of said Future Tickets to said seller and said auction winner after confirming available fund equal to payment amount for each of said Future Tickets in said escrow account designated to said auction winner; and
distributing each of said Future Tickets to said auction winner and said available fund equal to payment amount for each of said Future Tickets to said seller.

9. The method of claim 7 or 8, further comprising:
providing a means for said database to retrieve a market price of a wager for said future sporting event from said data repository wherein said data repository is a sports book.

10. The method of claim 9, further comprising:
distributing each of said Future Tickets to said auction winner by providing a means to hold each of said Future Tickets until a winning wager is determined for said future sporting event and to distribute a net value represented by said winning wager minus amount owed from transactions of exchanging each of said Future Tickets into said escrow account.

11. The method of claim 10, further comprising:
auctioning for a predetermined period defined as from time each of said Future Tickets is displayed on said website for a purpose of said auctioning until a winner of said auctioning is notified, wherein said predetermined period is between 24 hours and 48 hours or until an entered price matches said Donkey Discount of each of said Future Tickets.

12. The method of claim 11, further comprising:
registering in said database and maintaining said user information in said database wherein said database is a cloud application over Internet.

13. A method for providing an on-line sports wagers marketplace system comprising the following steps:
registering and maintaining user information wherein said user information includes a protected personal identifier and a third party entity chosen to sponsor on-line transactions;
providing a user interface module having a user interface for a registered user and a proxy for escrow accounts on a website such that said website provides an intermediary marketplace for selling and buying transferable physical tickets related to future sporting events;
editing using said user interface module to list said transferable physical tickets with minimum prices for selling said transferable physical tickets and maximum prices for buying said transferable physical tickets;
verifying legitimacy of said transferable physical tickets by retrieving market prices and purchase information associated with said transferable physical tickets from at least another data repository and securing said transferable physical tickets;
starting said on-line transactions for entering prices on said website to sell and buy said transferable physical tickets with said minimum prices and said maximum prices; and
completing said on-line transactions for selling and buying of said transferable physical tickets on said website, wherein before the completion of said on-line transactions confirming available fund in said escrow accounts to pay for said transferable physical tickets, having evaluated a plurality of said prices entered and determined buyers for said transferable physical tickets, transferring of said transferable physical tickets from said sellers' escrow accounts to said buyers' escrow accounts and payments from said buyers' escrow accounts to said sellers' escrow accounts, and notifying said buyers and said sellers of said on-line transactions.

14. The method of claim 13, further comprising:
registering and maintaining said user information wherein said user information includes a preferred notification contact means.

15. The method of claim 14, further comprising:
registering and maintaining said user information including said preferred notification contact means wherein said preferred notification contact means is a mail, an expedited service mail, a certified mail, an insured mail, a telephone call, or an electronic transmission.

16. The method of claim 15, further comprising:
providing a means to enable said user interface module retrieving a plurality of data repository and servers.

17. The method of claim 16, further comprising:
providing said user interface module wherein said user interface module includes a template to list said transferable physical tickets, said minimum prices, and said maximum prices.

18. The method of claim 17, further comprising:
auctioning for a predetermined period defined as from time at least one of said transferable physical tickets are displayed on said website for a purpose of said auctioning until a winner of said auctioning for at least one of said transferable physical tickets is notified, wherein said predetermined period is between 24 hours and 48 hours or until each of said prices matches each of said maximum prices, and wherein said on-line sports wagers marketplace is an on-line auction marketplace.

19. The method of claim 18, further comprising:
editing using said user interface module to list said transferable physical tickets with said minimum prices for selling said transferable physical tickets and said maximum prices for buying said transferable physical tickets, wherein said transferable physical tickets are Future Tickets representing wagers on future sporting events, and wherein said minimum prices are Bottom Prices selected by said sellers to sell said Future Tickets, and wherein said maximum prices are Donkey Discounts and at least 96% of said market prices.

20. The method of claim 19, further comprising:
distributing of said Future Tickets to winners of said on-line auction marketplace by providing a means to hold said Future Tickets until winning wagers are determined for said future sporting events and to distribute net values represented by said winning wagers minus amount owed from transactions of exchanging said Future Tickets into said escrow accounts.

21. The method of claim 20, further comprising:
verifying legitimacy of said transferable physical tickets wherein said registered users who enlist said transferable physical tickets in said on-line transactions by delivering said transferable physical tickets to a repository address provided on said website.

22. The method of claim 21, further comprising:
registering in said database and maintaining said user information in said database wherein said database is a cloud application over Internet.

23. A method of providing an on-line sports wagers marketplace system having a registration module to input user information in a database and registers with said system as a registered user, a user interface module having a template, a user input interface for said registered user, and a proxy for escrow accounts on a website, and a communication module for communicating with said user interface module and one or more items from a group consisting of a user terminal, said database, a data repository, an escrow account, a server, and an algorithm module wherein said algorithm module is capable of querying, evaluating, and displaying data such that said data are communicated using said communication module comprising the following steps:
registering and maintaining user information wherein said user information includes a protected personal identifier and a third party entity chosen to sponsor on-line transactions;
providing a user interface module having a user interface for a registered user and a proxy for escrow accounts on a website such that said website provides an intermediary marketplace for selling and buying transferable physical tickets related to future sporting events;
editing using said user interface module to list said transferable physical tickets with minimum prices for selling said transferable physical tickets and maximum prices for buying said transferable physical tickets;
verifying legitimacy of said transferable physical tickets by retrieving market prices and purchase information associated with said transferable physical tickets from at least another data repository and securing said transferable physical tickets;
starting said on-line transactions for entering prices on said website to sell and buy said transferable physical tickets with said minimum prices and said maximum prices; and
completing said on-line transactions for selling and buying of said transferable physical tickets on said website, wherein before the completion of said on-line transactions confirming available fund in said escrow accounts to pay for said transferable physical tickets, having evaluated a plurality of said prices entered and determined buyers for said transferable physical tickets, transferring of said transferable physical tickets from said sellers' escrow accounts to said buyers' escrow accounts and payments from said buyers' escrow accounts to said sellers' escrow accounts, and notifying said buyers and said sellers of said on-line transactions.

24. The method of claim 23, further comprising:
registering and maintaining said user information includes a preferred notification contact means.

25. The method of claim 24, further comprising:
registering and maintaining said user information includes said preferred notification contact means wherein said preferred notification contact means is a mail, an expedited service mail, a certified mail, an insured mail, a telephone call, or an electronic transmission.

26. The method of claim 25, further comprising:
providing a means to enable said user interface module retrieving a plurality of data repository and servers.

27. The method of claim 26, further comprising:
providing said user interface module wherein said user interface module includes a template to list said transferable physical tickets, said minimum prices, and said maximum prices.

28. The method of claim 27, further comprising:
auctioning for a predetermined period defined as from time at least one of said transferable physical tickets are displayed on said website for a purpose of said auctioning until a winner of said auctioning for at least one of said transferable physical tickets is notified, wherein said predetermined period is between 24 hours and 48 hours or until each of said prices matches each of said maximum prices, and wherein said on-line sports wagers marketplace is an on-line auction marketplace.

29. The method of claim 28, further comprising:
editing using said user interface module to list said transferable physical tickets with said minimum prices for selling said transferable physical tickets and said maximum prices for buying said transferable physical tickets, wherein said transferable physical tickets are Future Tickets representing wagers on future sporting events, and wherein said minimum prices are Bottom Prices selected by said sellers to sell said Future Tickets, and wherein said maximum prices are Donkey Discounts and at least 96% of said market prices.

30. The method of claim 29, further comprising:
distributing of said Future Tickets to winners of said on-line auction marketplace by providing a means to hold said Future Tickets until winning wagers are determined for said future sporting events and to distribute net values represented by said winning wagers minus amount owed from transactions of exchanging said Future Tickets into said escrow accounts.

31. The method of claim 30, further comprising:
verifying legitimacy of said transferable physical tickets wherein said registered users who enlist said transferable physical tickets in said on-line transactions by delivering said transferable physical tickets to a repository address provided on said website.

32. The method of claim 31, further comprising:
registering in said database and maintaining said user information in said database wherein said database is a cloud application over Internet.

33. A computer implemented method including at least one non-transitory computer-usable readable storage medium having at least one non-transitory computer-readable program code embodied therein for causing a computer system to perform a method of providing an on-line sports wagers marketplace system:
registering and maintaining user information wherein said user information includes a protected personal identifier and a third party entity chosen to sponsor on-line transactions;
providing a user interface module having a user interface for a registered user and a proxy for escrow accounts on a website such that said website provides an intermediary marketplace for selling and buying transferable physical tickets related to future sporting events;
editing using said user interface module to list said transferable physical tickets with minimum prices for selling said transferable physical tickets and maximum prices for buying said transferable physical tickets;
verifying legitimacy of said transferable physical tickets by retrieving market prices and purchase information associated with said transferable physical tickets from at least another data repository and securing said transferable physical tickets;
starting said on-line transactions for entering prices on said website to sell and buy said transferable physical tickets with said minimum prices and said maximum prices; and
completing said on-line transactions for selling and buying of said transferable physical tickets on said website, wherein before the completion of said on-line transactions confirming available fund in said escrow accounts to pay for said transferable physical tickets, having evaluated a plurality of said prices entered and determined buyers for said transferable physical tickets, transferring of said transferable physical tickets from said sellers' escrow accounts to said buyers' escrow accounts and payments from said buyers' escrow accounts to said sellers' escrow accounts, and notifying said buyers and said sellers of said on-line transactions.

34. The method of claim 33, further comprising:
registering and maintaining said user information wherein said user information includes a preferred notification contact means.

35. The method of claim 34, further comprising:
registering and maintaining said user information includes said preferred notification contact means wherein said preferred notification contact means is a mail, an expedited service mail, a certified mail, an insured mail, a telephone call, or an electronic transmission.

36. The method of claim 35, further comprising:
providing a means to enable said user interface module retrieving a plurality of data repository and servers.

37. The method of claim 36, further comprising:
providing said user interface module wherein said user interface module includes a template to list said transferable physical tickets, said minimum prices, and said maximum prices.

38. The method of claim 37, further comprising:
auctioning for a predetermined period defined as from time at least one of said transferable physical tickets are displayed on said website for a purpose of said auctioning until a winner of said auctioning for at least one of said transferable physical tickets is notified, wherein said predetermined period is between 24 hours and 48 hours or until each of said prices matches each of said maximum prices, and wherein said on-line sports wagers marketplace is an on-line auction marketplace.

39. The method of claim 38, further comprising:
editing using said user interface module to list said transferable physical tickets with said minimum prices for selling said transferable physical tickets and said maximum prices for buying said transferable physical tickets, and wherein said transferable physical tickets are Future Tickets representing wagers on future sporting events, and wherein said minimum prices are Bottom Prices selected by said sellers to sell said Future Tickets, and wherein said maximum prices are Donkey Discounts and at least 96% of said market prices.

40. The method of claim 39, further comprising:
distributing of said Future Tickets to winners of said on-line auction marketplace by providing a means to hold said Future Tickets until winning wagers are determined for said future sporting events and to distribute net values represented by said winning wagers minus amount owed from transactions of exchanging said Future Tickets into said escrow accounts.

41. The method of claim 40, further comprising:
verifying legitimacy of said transferable physical tickets wherein said registered users who enlist said transferable physical tickets in said on-line transactions by delivering said transferable physical tickets to a repository address provided on said website.

42. The method of claim 41, further comprising:
registering in said database and maintaining said user information in said database wherein said database is a cloud application over Internet.

43. A computer-implemented platform including a non-transitory computer-usable readable storage medium having non-transitory computer-readable program codes embodied therein for causing an on-line sports wagers marketplace computer system to perform steps in exchanging transferable physical tickets related to future sporting events comprising:
a custom computer platform;
a registration module to input user information, wherein said user information includes a preferred notification contact means, and to register with said on-line sports wagers marketplace system as a registered user;
a user interface module having a template and a user input interface for said registered user to register with said on-line sports wagers marketplace system, and a proxy for escrow accounts on a website, wherein said website provides an intermediary marketplace for selling and buying transferable physical tickets related to future sporting events, wherein said user input interface allowing to enter one or more inputs selected from a group consisting of protected login, numeric, alphanumeric, image, audio, video, hyperlink, and text entries, and wherein said proxy for escrow accounts allows to confirm, secure, and transfer available fund in said escrow accounts in conjunction with transactions involving selling and buying said transferable physical tickets;
a database for storing said user information for said registered user, wherein said user information is identified to said registered user and enabled for querying, evaluating, and displaying; and
a communication module for communicating with said user interface module and one or more items from a group consisting of a user terminal, said database, a data repository, an escrow account, a server, and an algorithm module, wherein said algorithm module is capable of querying, evaluating, and displaying data such that said data are communicated using said communication module.

44. The computer-implemented platform of claim 43, wherein said registration module further comprises of one or more preferred notification contact means from a group consisting of a mail, an expedited service mail, a certified mail, an insured mail, a telephone call, or an electronic transmission in said user information.

45. The computer-implemented platform of claim 44, wherein said user interface module is adapted to further allow said registered user to designate said communication module and said algorithm module authorized to access said user information, said database, and said escrow accounts related to on-line sports wagers marketplace transactions by said registered user, wherein said communication module and said algorithm module are adapted to further allow verification of data, transfer of funds in said escrow accounts, and display a transaction status related to said on-line sports wagers marketplace transactions by said registered user.

46. The computer-implemented platform of claim 45, wherein said template further comprises of selection and displays of said transferable physical tickets, minimum prices chosen to sell said transferable physical tickets, maximum prices determined by said algorithm module to sell said transferable physical tickets, and buyers determined by said algorithm module to successfully purchase said transferable physical tickets.

47. The computer-implemented platform of claim 46, wherein said on-line sports wagers marketplace system is an on-line auction marketplace system that further provides auctioning of said transferable physical tickets.

48. One or more processor readable storage devices having processor readable codes embodied on at least one processor readable storage device, said processor readable codes for causing at least one processor readable storage device to perform a method of providing an on-line sports wagers marketplace system comprising:
registering and maintaining user information wherein said user information includes a protected personal identifier and a third party entity chosen to sponsor on-line transactions;
providing a user interface module having a user interface for a registered user and a proxy for escrow accounts on a website such that said website provides an intermediary marketplace for selling and buying transferable physical tickets related to future sporting events;
editing using said user interface module to list said transferable physical tickets with minimum prices for selling said transferable physical tickets and maximum prices for buying said transferable physical tickets;
verifying legitimacy of said transferable physical tickets by retrieving market prices and purchase information associated with said transferable physical tickets from at least another data repository and securing said transferable physical tickets;
starting said on-line transactions for entering prices on said website to sell and buy said transferable physical tickets with said minimum prices and said maximum prices; and
completing said on-line transactions for selling and buying of said transferable physical tickets on said website, wherein before the completion of said on-line transactions confirming available fund in said escrow accounts to pay for said transferable physical tickets, having evaluated a plurality of said prices entered and determined buyers for said transferable physical tickets, transferring of said transferable physical tickets from said sellers' escrow accounts to said buyers' escrow accounts and payments from said buyers' escrow accounts to said sellers' escrow accounts, and notifying said buyers and said sellers of said on-line transactions.

49. The method of claim 48, further comprising:
registering and maintaining said user information wherein said user information includes a preferred notification contact means.

50. The method of claim 49, further comprising:
registering and maintaining said user information includes said preferred notification contact means wherein said preferred notification contact means is a mail, an expedited service mail, a certified mail, an insured mail, a telephone call, or an electronic transmission.

51. The method of claim 50, further comprising:
providing a means to enable said user interface module retrieving a plurality of data repository and servers.

52. The method of claim 51, further comprising:
providing said user interface module wherein said user interface module includes a template to list said transferable physical tickets, said minimum prices, and said maximum prices.

53. The method of claim 52, further comprising:
auctioning for a predetermined period defined as from time at least one of said transferable physical tickets are displayed on said website for a purpose of said auctioning until a winner of said auctioning for at least one of said transferable physical tickets is notified, wherein said predetermined period is between 24 hours and 48 hours or until each of said prices matches each of said maximum prices, and wherein said on-line sports wagers marketplace is an on-line auction marketplace.

54. The method of claim 53, further comprising:
editing using said user interface module to list said transferable physical tickets with said minimum prices for selling said transferable physical tickets and said maximum prices for buying said transferable physical tickets, wherein said transferable physical tickets are Future Tickets representing wagers on future sporting events, and wherein said minimum prices are Bottom Prices selected by said sellers to sell said Future Tickets, and wherein said maximumprices are Donkey Discounts and at least 96% of said market prices.

55. The method of claim 54, further comprising:
distributing of said Future Tickets to winners of the on-line auction marketplace by providing a means to hold said Future Tickets until winning wagers are determined for said future sporting events and to distribute net values represented by said winning wagers minus amount owed from transactions of exchanging said Future Tickets into said escrow accounts.

56. The method of claim 55, further comprising:
verifying legitimacy of said transferable physical tickets wherein said registered users who enlist said transferable physical tickets in said on-line transactions by delivering said transferable physical tickets to a repository address provided on said website.

57. The method of claim 56, further comprising:
registering in said database and maintaining said user information in said database wherein said database is a cloud application over Internet.

58. A non-transitory computer-usable readable storage medium for an on-line sports wagers marketplace structure, comprising:
(a) program code for registering and maintaining user information wherein said user information includes a protected personal identifier and a third party entity chosen to sponsor on-line transactions;
(b) program code for providing a user interface module having a user interface for a registered user and a proxy for escrow accounts on a website such that said website provides an intermediary marketplace for selling and buying transferable physical tickets related to future sporting events;
(c) program code for editing using said user interface module to list said transferable physical tickets with minimum prices for selling said transferable physical tickets and maximum prices for buying said transferable physical tickets;
(d) program code for verifying legitimacy of said transferable physical tickets by retrieving market prices and purchase information associated with said transferable physical tickets from at least another data repository and securing said transferable physical tickets;
(e) program code for starting said on-line transactions for entering prices on said website to sell and buy said transferable physical tickets with said minimum prices and said maximum prices; and
(f) program code for completing said on-line transactions for selling and buying of said transferable physical tickets on said website, wherein before the completion of said on-line transactions confirming available fund in said escrow accounts to pay for said transferable physical tickets, having evaluated a plurality of said prices entered and determined buyers for said transferable physical tickets, transferring of said transferable physical tickets from said sellers' escrow accounts to said buyers' escrow accounts and payments from said buyers' escrow accounts to said sellers' escrow accounts, and notifying said buyers and said sellers of said on-line transactions.

59. One or more processor readable storage devices having, processor readable codes embodied on at least one processor readable storage device, said processor readable codes for causing at least one processor readable storage device to perform a method of providing an on-line sports wagers marketplace system for selling and buying Future Tickets comprising:
having said on-line sports wagers marketplace system further adopted to provide an on-line auction marketplace system;
registering in a database and maintaining user information in said database;
providing a user interface module having a template, a user interface for a registered user, and a proxy for escrow accounts on a website such that said website provides an intermediary marketplace for selling and buying Future Tickets wherein said Future Tickets are transferable physical tickets representing wagers on future sporting events;
listing each of said Future Tickets with purchase information by a registered user who is a seller using said user interface module on said website;
selecting a Bottom Price by said seller to sell each of said Future Tickets on said website wherein said Bottom Price is a minimum price chosen to sell at least one of said Future Tickets;
providing a means for said database to retrieve a market price of a wager for said future sporting event from at least another data repository to calculate a Donkey Discount wherein said Donkey Discount is at least 96% of said market price and a maximum price determined to sell at least one of said Future Tickets;
verifying legitimacy of said Future Tickets by securing said Future Tickets from said sellers and confirming said purchase information in said database against said data repository;
displaying each of said Future Tickets with said Bottom Price and said Donkey Discount on said website;
entering a bid price in an auction to purchase each of said Future Tickets by a plurality of said registered user who is a buyer on said website;
providing a means for determining an auction winner for each of said Future Tickets by retrieving and evaluating a plurality of said bid price;
notifying selling each of said Future Tickets to said seller and said auction winner after confirming available fund equal to payment amount for each of said Future Tickets in said escrow account designated to said auction winner; and
distributing each of said Future Tickets to said auction winner and said available fund equal to payment amount for each of said Future Tickets to said seller.

60. The method of claim 59, further comprising:
providing a means for said database to retrieve a market price of a wager for said future sporting event from said data repository wherein said data repository is a sports book.

61. The method of claim 60, further comprising:
distributing each of said Future Tickets to said auction winner by providing a means to hold each of said Future Tickets until a winning wager is determined for said future sporting event and to distribute a net value represented by said winning wager minus amount owed from transactions of exchanging each of said Future Tickets into said escrow account.

62. The method of claim 61, further comprising:
running said auction for a predetermined period defined as from time each of said Future Tickets is displayed on said website for a purpose of said auction until said auction winner is notified, wherein said predetermined period is between 24 hours and 48 hours or until said bid price matches said Donkey Discount of each of said Future Tickets.

63. The method of claim 62, further comprising:
registering in said database and maintaining said user information in said database wherein said database is a cloud application over Internet.

64. A non-transitory computer-usable readable storage medium for an on-line sports wagers marketplace structure for selling and buying Future Tickets comprising:
(a) program code for having said on-line sports wagers marketplace system further adopted to provide an on-line auction marketplace system;
(b) program code for registering in a database and maintaining user information in said database;
(c) program code for providing a user interface module having a template, a user interface for a registered user, and a proxy for escrow accounts on a website such that said website provides an intermediary marketplace for selling and buying Future Tickets wherein said Future Tickets are transferable physical tickets representing wagers on future sporting events;
(d) program code for listing each of said Future Tickets with purchase information by a registered user who is a seller using said user interface module on said website;
(e) program code for selecting a Bottom Price by said seller to sell each of said Future Tickets on said website wherein said Bottom Price is a minimum price chosen to sell at least one of said Future Tickets;
(f) program code for providing a means for said database to retrieve a market price of a wager for said future sporting event from at least another data repository to calculate a Donkey Discount wherein said Donkey Discount is at least 96% of said market price and a maximum price determined to sell at least one of said Future Tickets;
(g) program code for verifying legitimacy of said Future Tickets by securing said Future Tickets from said sellers and confirming said purchase information in said database against said data repository;
(h) program code for displaying each of said Future Tickets with said Bottom Price and said Donkey Discount on said website;
(i) program code for entering a bid price in an auction to purchase each of said Future Tickets by a plurality of said registered user who is a buyer on said website;
(j) program code for providing a means for determining an auction winner for each of said Future Tickets by retrieving and evaluating a plurality of said bid price;
(k) program code for notifying selling each of said Future Tickets to said seller and said auction winner after confirming available fund equal to payment amount for each of said Future Tickets in said escrow account designated to said auction winner; and
(l) program code for distributing each of said Future Tickets to said auction winner and said available fund equal to payment amount for each of said Future Tickets to said seller.
